(19) United States
(12) Patent Application Publication
(10) Pub. No.: US 2017/0112706 A1
(43) Pub. Date: Apr. 27, 2017

(54) FOLDABLE WALKER

(71) Applicants: Liza Bruk, Walnut Creek, CA (US); Gerald Dave A. Ferrer, Pittsburgh, PA (US); Rebecca Hartley, Latrobe, PA (US); Jaclyn LaRosa Sittnick, McMurray, PA (US); Stephanie Quatchak, Pittsburgh, PA (US); Eric B. Weston, Pittsburgh, PA (US)

(72) Inventors: Liza Bruk, Walnut Creek, CA (US); Gerald Dave A. Ferrer, Pittsburgh, PA (US); Rebecca Hartley, Latrobe, PA (US); Jaclyn LaRosa Sittnick, McMurray, PA (US); Stephanie Quatchak, Pittsburgh, PA (US); Eric B. Weston, Pittsburgh, PA (US)

(21) Appl. No.: 15/332,698

(22) Filed: Oct. 24, 2016

Related U.S. Application Data
(60) Provisional application No. 62/246,140, filed on Oct. 26, 2015.

(51) Int. Cl. A61H 3/04

(52) U.S. Cl. CPC A61H 3/04; A61H 2201/1635; A61H 2201/0161

(57) ABSTRACT

A foldable walker has a first frame rotatably connected to a joint flange and a second frame fixedly connected to the joint flange. The first frame is rotatable toward and away from the second frame around a folding axis defined by the connection of the first frame to the joint flange. A platform is connected to the first frame and the second frame.

### CROSS-REFERENCE TO RELATED APPLICATIONS

This patent application is a non-provisional application filed under 35 U.S.C. §111(a) and claims priority under 35 U.S.C. §119(e) to U.S. Provisional Patent Application No. 62/246,140, filed on Oct. 26, 2015. U.S. Provisional Patent Application No. 62/246,140 is incorporated-by-reference into this specification.

### BACKGROUND

The information described in this background section is not admitted to be prior art.

Walkers are used by individuals with limited ambulatory mobility. Walkers provide increased stability during gait, which improves mobility and facilitates locomotion. Walkers can be categorized into a number of types, including standard walkers, wheeled walkers (also known as rollators), and rehabilitation walkers (also known as platform walkers or walking tables).

Standard walkers generally comprise four legs and either zero wheels or two wheels (one attached to each of the front legs). Standard walkers generally have horizontally-positioned hand grips and are operated by repetitive lifting—i.e., while standing behind the walker and grasping the grips, the user steps towards the walker, lifts the walker forward, steps towards the walker again, lifts the walker forward again, and so on. Wheeled walkers, as the name indicates, generally comprise four legs with wheels attached to each leg. Like standard walkers, wheeled walkers generally have horizontally-positioned hand grips. Unlike standard walkers, wheeled walkers are not operated by repetitive forward lifting during locomotion; instead, while standing behind a wheeled walker and grasping the grips, the user simply steps forward while pushing the walker, which rolls horizontally along with the user.

Standard walkers and wheeled walkers are typically used as long-term mobility aids, for example, by elderly individuals and individuals with chronic mobility impairment. Rehabilitation walkers, however, are generally used for gait rehabilitation. For example, platform walkers may be used with patients suffering from debilitating injuries to their lower limbs, after orthopedic surgeries, with new prosthetics after amputations, or with stroke victims to enhance the patients' stability during gait while relearning how to walk. Unlike standard and wheeled walkers, which are often used in patients' homes and during their daily activities, rehabilitation walkers are typically used solely in rehabilitation clinics.

Rehabilitation walkers generally have four legs with wheels attached to each leg, vertically-positioned hand grips, and a horizontally-positioned platform or tray that provides a support surface for patients' forearms. Rehabilitation walkers operate by providing standing support to patients' upper bodies during gait. During operation, patients grasp the vertically-positioned hand grips, rest their forearms on the platform/tray, thereby supporting the weight of their upper body, and walk while pushing the rehabilitation walker, which rolls horizontally along with the user.

### SUMMARY

The invention described in this specification relates to walkers, more particularly to foldable walkers, and even more particularly to foldable rehabilitation walkers.

In one example, a foldable walker comprises a first frame rotatably connected to a joint flange and a second frame fixedly connected to the joint flange. The first frame is rotatable toward and away from the second frame around a folding axis defined by the connection of the first frame to the joint flange. A platform is connected to the first frame and the second frame.

In another example, a foldable walker comprises a first frame rotatably connected to a joint flange and a second frame fixedly connected to the joint flange, wherein the first frame and the second frame are oriented in a V-shape. The first frame is rotatable toward and away from the second frame around a folding axis defined by the connection of the first frame to the joint flange. The foldable walker further comprises a first wheel assembly connected to the first frame, a second wheel assembly connected to the second frame, and a third wheel assembly connected to the joint flange. A joint stabilization bracket is connected to the first frame and the second frame. A first platform support assembly is telescopingly connected to the first frame, and a second platform support assembly is telescopingly connected to the second frame. A platform is releasably connected to the first platform support assembly, and is rotatably connected to the second platform support assembly.

In another example, a foldable walker comprises a first frame rotatably connected to a joint flange and a second frame fixedly connected to the joint flange, wherein the first frame and the second frame are oriented in a V-shape. The first frame is rotatable toward and away from the second frame around a folding axis defined by the connection of the first frame to the joint flange. The first frame and the second frame each comprise a front vertical member, a rear vertical member, an upper horizontal member, and a lower horizontal member. The upper horizontal member and the lower horizontal member are each connected to the front vertical member and the rear vertical member. The front vertical member of the first frame is rotatably connected to the joint flange, and the front vertical, member of the second frame is fixedly connected to the joint flange. The foldable walker further comprises a first wheel assembly connected to the rear vertical member of the first frame, a second wheel assembly connected to the rear vertical member of the second frame, and a third wheel assembly connected to the joint flange. A joint stabilization bracket is connected to the front vertical member of the first frame and to the front vertical member of the second frame. The joint stabilization bracket is fixedly connected to the second frame so that the second frame has no rotational degrees of freedom relative to the joint stabilization bracket. The joint stabilization bracket is not fixedly connected to the first frame so that the first frame has rotational degrees of freedom relative to the joint stabilization bracket. A first platform support assembly is telescopingly connected to the first frame, and a second platform support assembly is telescopingly connected to the second frame. The first platform support assembly and the second platform support assembly each comprise a front telescoping member and a rear telescoping member connected to opposite ends of a platform-connecting member. A platform is releasably connected to the platform-connecting member of the first platform support assembly. The platform is rotatably connected through a dual-axis hinge to the platform-connecting member of the second platform support assembly.

It is understood that the invention described in this specification is not necessarily limited to the examples summarized in this Summary.

### BRIEF DESCRIPTION OF THE DRAWINGS

Various features and characteristics of the inventions described in this specification may be better understood by reference to the accompanying figures, in which:

FIGS. 1A-1D are perspective views of a foldable walker in an unfolded configuration;

FIG. 2A is a side view of a main frame of a foldable walker; FIG. 2B is a perspective view of the main frame shown in FIG. 2A;

FIG. 3A is a side view of a wheel assembly of a foldable walker; FIG. 3B is a perspective view of the wheel assembly shown in FIG. 3A;

FIG. 4A is a perspective view of the top side of a joint flange of a foldable walker; FIG. 4B is a perspective view of the bottom side of the joint flange shown in FIG. 4A;

FIGS. 5A and 5B are perspective views of a lower-front portion of a foldable walker showing the connection of a front wheel assembly and two main frames to a joint flange; FIG. 5C is a cross-sectional view of a lower-front portion of a foldable walker showing the connection of a front wheel assembly and two main frames to a joint flange;

FIGS. 6A-6D are perspective views of a foldable walker in a folded configuration;

FIG. 7A is a perspective view of a joint stabilization bracket; FIG. 7B is a top view of the joint stabilization bracket shown in FIG. 6A;

FIG. 8 is a perspective view of a middle-front portion of a foldable walker showing the connection of a joint stabilization bracket to the two main frames of the foldable walker;

FIG. 9 is a perspective view of a platform support assembly of a foldable walker;

FIG. 10 is a perspective view showing the alignment of the platform support assembly shown in FIG. 9 with the main frame shown in FIGS. 2A and 2B;

FIGS. 11A and 11B are perspective views of a platform of a foldable walker;

FIG. 12 is a bottom view of the platform shown in FIGS. 10A and 10B connected to the platform support assembly shown in FIG. 8;

FIG. 13A is a side view schematic diagram showing the connection of a magnetic lock to a platform and a platform-connecting member of a foldable walker; FIG. 13B is an end view schematic diagram corresponding to the side view schematic diagram of FIG. 13A;

FIG. 14A is a side view schematic diagram showing the connection of a dual-axis hinge to a platform and a platform-connecting member of a foldable walker; FIG. 14B is an end view schematic diagram corresponding to the side view schematic diagram of FIG. 14A; FIGS. 14C-14E are end view schematic diagrams collectively showing the folding of the platform from a horizontal position perpendicular to the platform support assembly (and the main frame, not shown) to a vertical folded position parallel and adjacent to the platform support assembly and the main frame;

FIG. 15A is a top view schematic diagram of a folding actuator connected to the two main frames of a foldable walker; FIG. 15B is a perspective view schematic diagram of the folding actuator shown in FIG. 15B;

FIGS. 16A-16D are photographs of a prototype foldable walker;

FIGS. 17A and 17B are photographs showing the connection of a front wheel assembly and two main frames to a joint flange of the prototype foldable walker shown in FIGS. 16A-16D;

FIG. 18 is a photograph of the middle-front portion of the prototype foldable walker shown in FIGS. 16A-16D showing the connection of a joint stabilization bracket to the two main frames;

FIG. 19 is a photograph showing the connection of magnetic locks to a platform and a platform support assembly of the prototype foldable walker shown in FIGS. 16A-16D;

FIGS. 20A-20D are photographs showing the connection of a dual-axis hinge to the platform and the platform support assembly of the prototype foldable walker shown in FIGS. 16A-16D; FIGS. 20A-20D also collectively show the folding of the platform from a horizontal position perpendicular to the platform support assembly and the main frame to a vertical folded position parallel and adjacent to the platform support assembly and the main frame; and

FIG. 21 is a photograph showing a folding actuator connected to the two main frames of the prototype foldable walker shown in FIGS. 16A-16D.

The reader will appreciate the foregoing features and characteristics, as well as others, upon considering the following detailed description of the inventions according to this specification.

### DESCRIPTION

In this specification, including the claims, terms of relative orientation, location, or positioning (e.g., top, bottom, left, right, vertical, horizontal, forward, rearward, front, rear, back, upper, lower, above, below, and the like) are to be construed from the perspective of a user of the described foldable walker.

As described above, rehabilitation walkers generally have four legs with wheels attached to each leg and a horizontally-positioned platform or tray that provides a support surface for patients' forearms. Conventional rehabilitation walkers suffer from a number of problems. For instance, conventional rehabilitation walkers are relatively large and take up significant amounts of space in rehabilitation clinics. Additionally, the support platform/tray visually obscures the lower portions of conventional rehabilitation walkers from users during operation. This latter issue is particularly problematic for prosthetic patients and other patients that have limited proprioception. The inability of such patients to see their lower limbs, feet, and/or prostheses during gait inhibits the patients' visual feedback, which can slow their rehabilitation. The foldable walker described in this specification addresses and overcomes these problems.

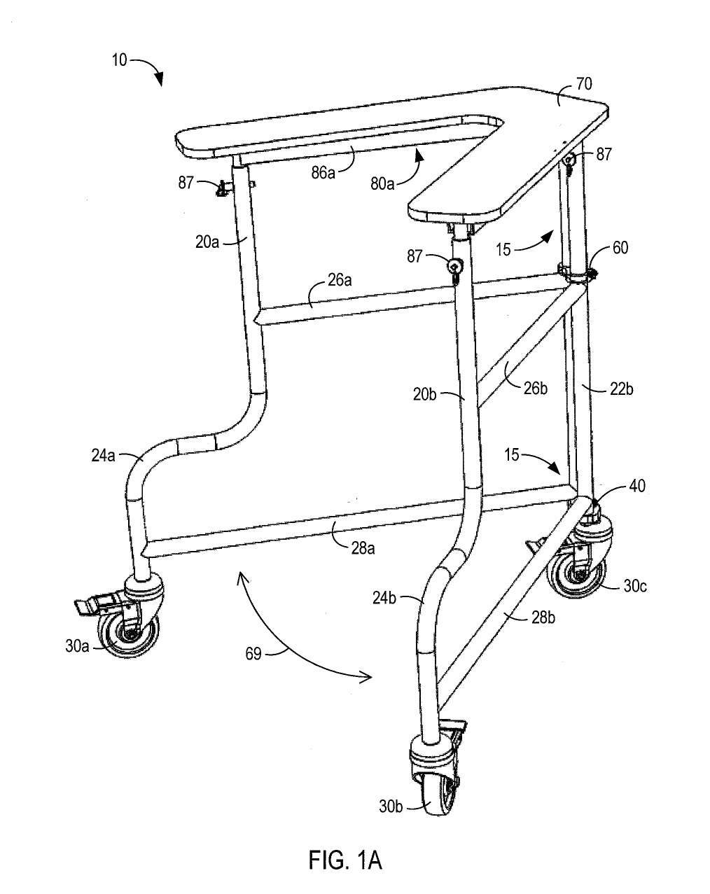

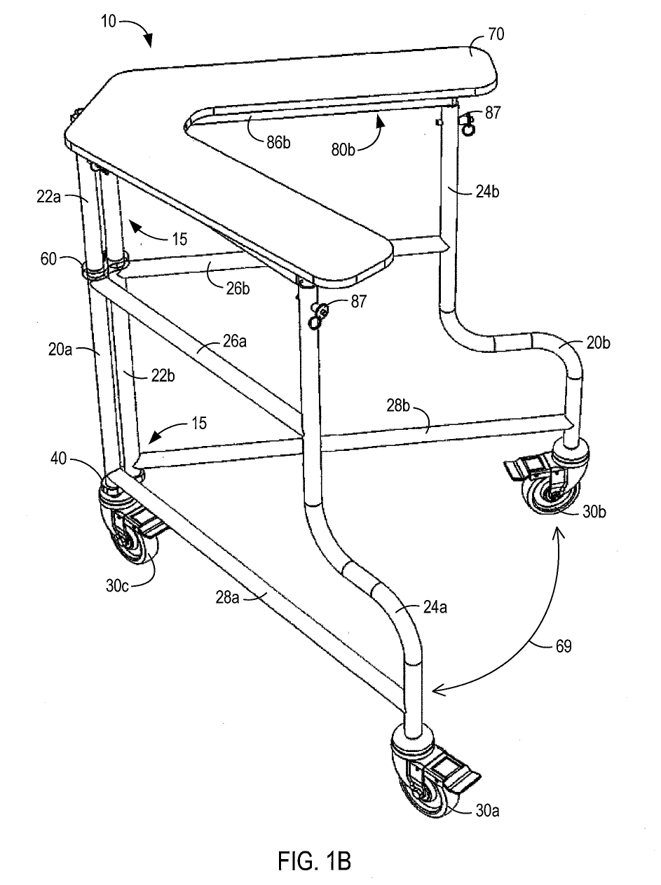

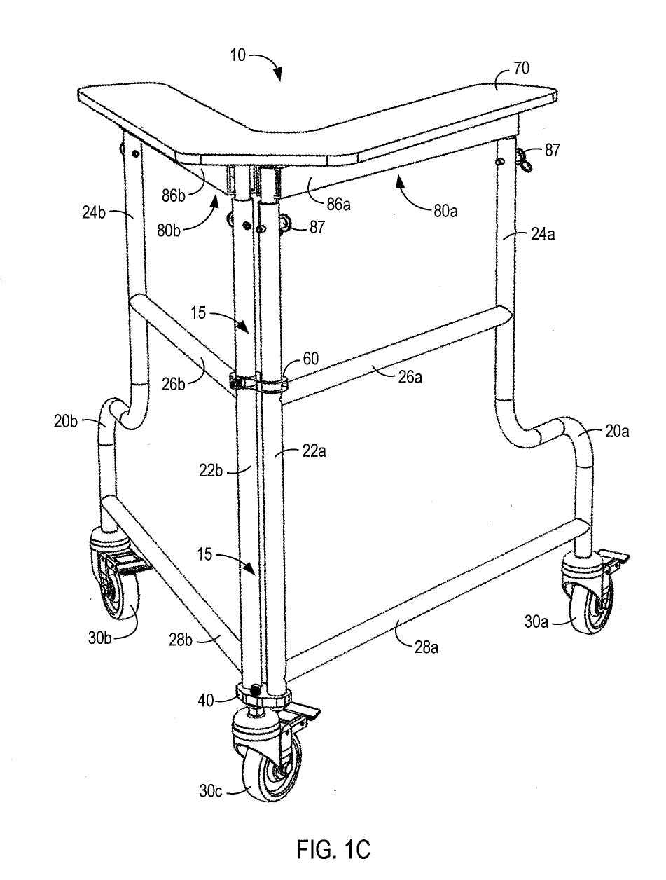

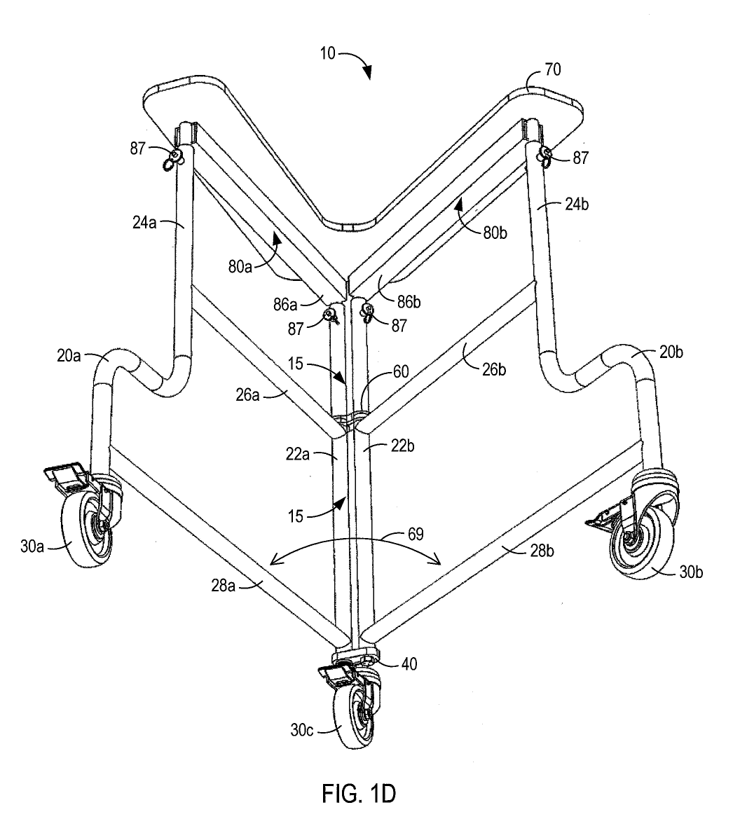

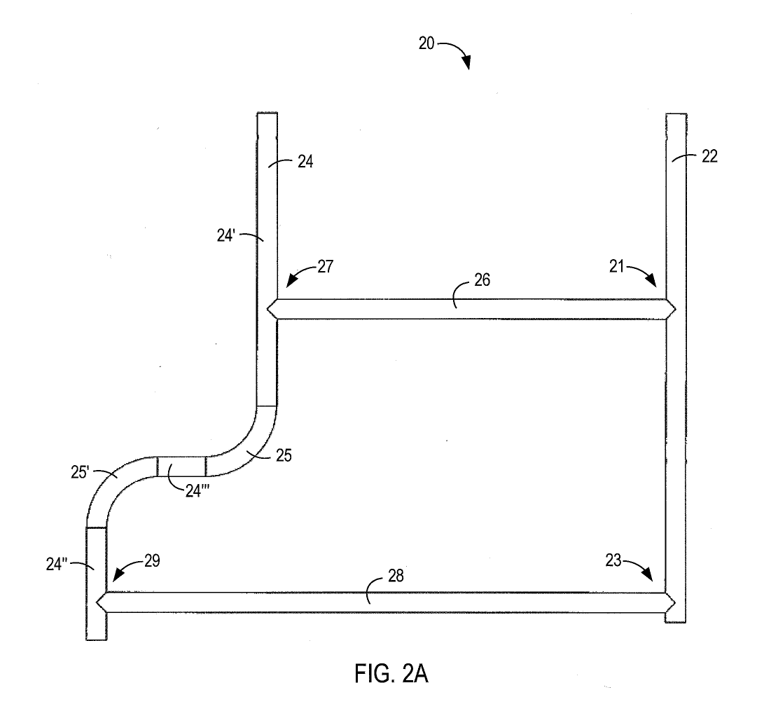

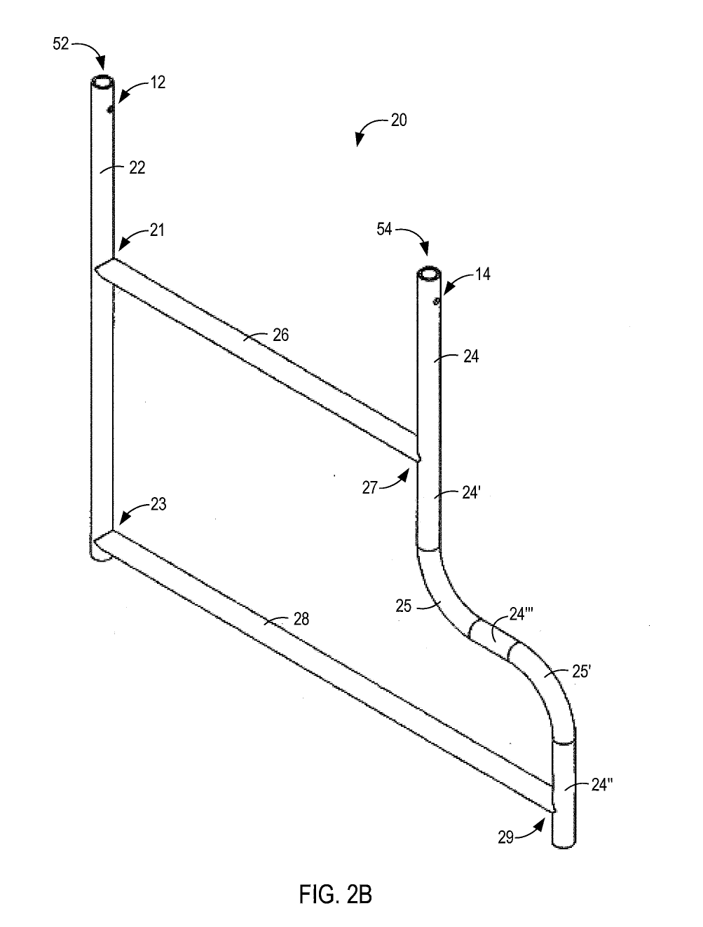

Referring to FIGS. 1A-1D, a foldable walker 10 comprises a first frame 20a and a second frame 20b. As shown in FIGS. 2A and 2B, a frame 20 (corresponding to the first frame 20a and the second frame 20b) comprises a front vertical member 22, a rear vertical member 24, an upper horizontal member 26, and a lower horizontal member 28 (in FIGS. 1A-1D, the constituent members of the frames 20a and 20b are indicated as 22a, 22b, 24a, 24b, 26a, 26b, 28a, and 28b). The upper horizontal member 26 and the lower horizontal member 28 are each connected to the front vertical member 22 and to the rear vertical member 24.

The first frame 20a and the second frame 20b further comprise height adjustment apertures. Referring to FIG. 2B, the frame 20 comprises a front height adjustment aperture 12 located toward the upper end of the front vertical member 22. The frame 20 also comprises a rear height adjustment aperture 14 located toward the upper end of the rear vertical member 24. The front vertical member 22 comprises a hollow lumen 52, and the rear vertical member 24 comprises a hollow lumen 54.

Still referring to FIGS. 2A and 2B, the front vertical member 22, the upper horizontal member 26, and the lower horizontal member 28 are each linear members of the frame 20, whereas the rear vertical member 24 is a curvilinear member comprising multiple interconnected segments. The rear vertical member 24 comprises an upper linear segment 24′, a lower linear segment 24″, an intermediate linear segment 24′″, an upper curved segment 25, and a lower curved segment 25′. The upper linear segment 24′ of the rear vertical member 24 is connected to the upper curved segment 25, which is connected to intermediate linear segment 24″, which is connected to lower curved segment 25′, which is connected to lower linear segment 24″. The upper linear segment 24′ and the lower linear segment 24″ are oriented vertically, the intermediate linear segment 24′″ is oriented horizontally, and the upper and lower curved segments 25 and 25′ provide transitions between the vertical and horizontal orientations of the respective linear segments.

The curvilinear rear vertical member 24 comprises two linear vertical segments, one linear horizontal segment, and two curved transitional segments. The upper horizontal member 26 connects the front vertical member 22 to the upper linear segment 24′ of the rear vertical member 24. The lower horizontal member 28 connects the front vertical member 22 to the lower linear segment 24′ of the rear vertical member 24. Although the rear vertical member 24 is shown as a curvilinear member, it is nevertheless understood that the rear vertical member of a frame of a foldable walker in accordance with this specification may be a linear member, like the front vertical member 22, or may have a different curvilinear shape comprising a different combination of linear and/or curved segments.

The constituent members of the first frame 20a and the second frame 20b (i.e., the front vertical member 22a/22b, the rear vertical member 24a/24b, the upper horizontal member 26a/26b, and the lower horizontal member 28a/28b) may be made of a material of construction such as, for example, aluminum or an aluminum-based alloy, titanium or a titanium-based alloy, steel, or a composite material (e.g., a fiber-reinforced polymer material such as, for example, carbon fiber-reinforced polymer). Hollow aluminum tubing or hollow aluminum-based alloy tubing (e.g., 6061-T6 aluminum alloy) provides an advantageous combination of low cost and high strength-to-weight ratio.

The constituent members of the first frame 20a and the second frame 20b may be connected together using a joining mechanism depending upon the material of construction of the members. Still referring to FIGS. 2A and 2B, the upper horizontal member 26 is connected to the front vertical member 22 at joint 21. The upper horizontal member 26 is connected to the rear vertical member 24 at joint 27. The lower horizontal member 28 is connected to the front vertical member 22 at joint 23. The lower horizontal member 28 is connected to the rear vertical member 24 at joint 29. In embodiments where the constituent members are made of a metallic material (such as 6061-T6 aluminum alloy, for example), the joints 21, 23, 27, and 29 may comprise welds between the members. Alternatively, the joints 21, 23, 27, and 29 may comprise mechanical fastening mechanisms such as threaded connections, for example.

In embodiments where the rear vertical member 24 comprises a curvilinear member, the constituent segments of the curvilinear member may be connected together using a joining mechanism or, alternatively, the constituent segments may correspond to regions formed from a single piece of material. For example, in embodiments where the rear vertical member 24 comprises a hollow metal tube or metal alloy tube (e.g., 6061-T6 aluminum alloy), a linear tube may be bent (i.e., plastically deformed) into the curvilinear shape of the member, wherein the constituent linear and curved segments respectively correspond to unbent and bent regions of the tube.

Referring again to FIGS. 1A-1D, the foldable walker 10 can further comprise a first wheel assembly 30a connected to the first frame 20a, and a second wheel assembly 30b connected to the second frame 20b. The first wheel assembly 30a is connected to the rear vertical member 24a of the first frame 20a, and the second wheel assembly 30b is connected to the rear vertical member 24b of the first frame 20b. The first and second wheel assemblies 30a and 30b form the rear wheels of the foldable walker 10.

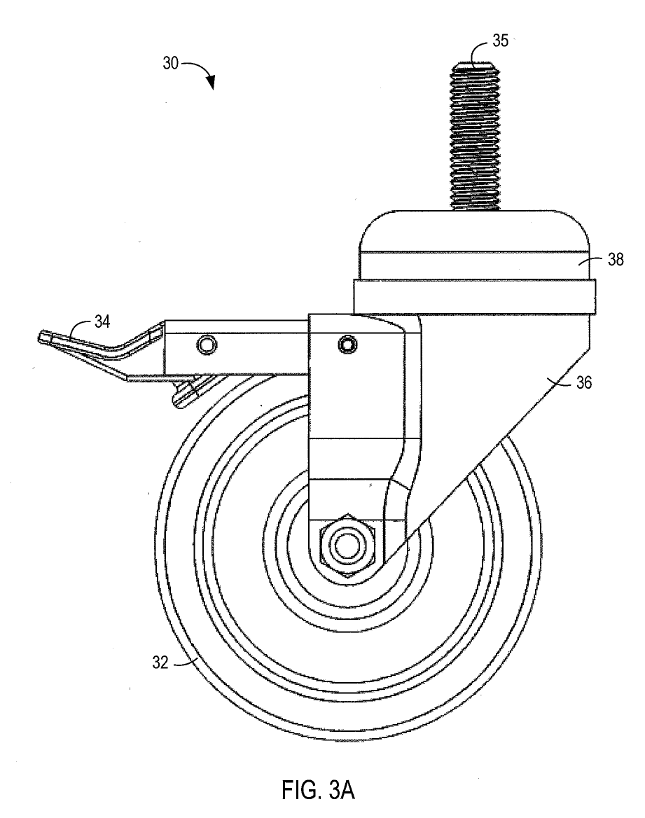

As shown in FIGS. 3A and 3B, a wheel assembly 30 (which corresponds to wheel assemblies 30a, 30b, and 30c in FIGS. 1A-1D) comprises a wheel 32 rotatably connected to a fork 36. The wheel assembly 30 also comprises a break 34 connected to the fork 36 and configured to releasably engage the wheel 32 to prevent rotation, for example, when the foldable walker 10 is not in use. The wheel assembly 30 further comprises a swivel joint 38 mounted on top of the fork 36. A connector 35 is mounted on top of the swivel joint 38. The swivel joint 38 provides the wheel 32, the break 34, and the fork 36 with rotational degrees of freedom in the horizontal plane relative to the connector 35.

In the embodiment shown in FIGS. 3A and 3B, the connector 35 comprises a threaded male coupling. A corresponding threaded female coupling (e.g., a female-threaded insert, not shown) can be embedded in the lower ends of the rear vertical members 24a and 24b (e.g., located in the lumens 54a and 54b of hollow metal or alloy tubes forming the rear vertical members 24a and 24b). As shown in FIGS. 1A-1D, the wheel assemblies 30a and 30b can be respectively connected to the first and second frames 20a and 20b through threaded connection into the rear vertical members 24a and 24b. The attachment of the connectors 35s and 35b to the rear vertical members 24a and 24b provide the first and second wheel assemblies 30a and 30b with rotational degrees of freedom in the horizontal plane relative to the first and second frames 20a and 20b. The first and second wheel assemblies 30a and 30b can alternatively be connected to the first and second frames 20a and 20b, respectively, through different connection mechanisms such as, for example, grip ring stems or welded connection.

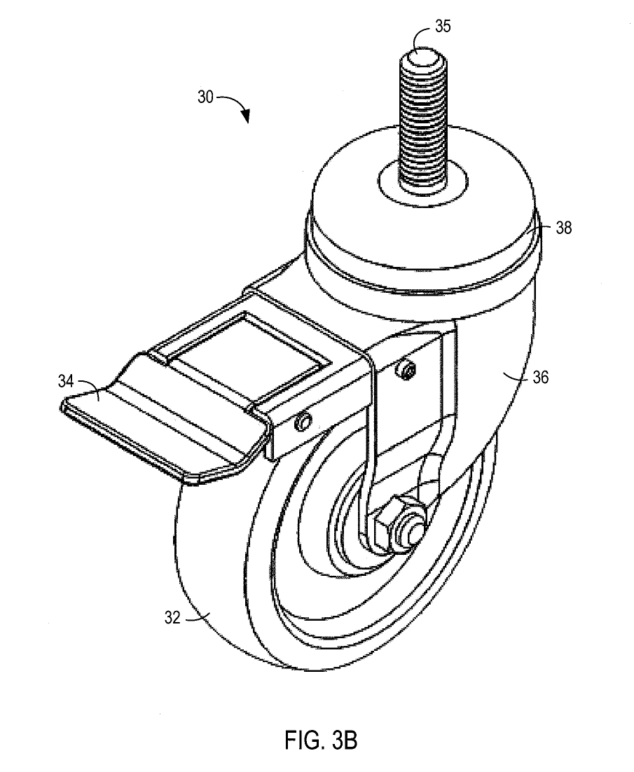

Referring again to FIGS. 1A-1D, the foldable walker 10 can further comprise a joint flange 40. As shown in FIGS. 4A and 4B, the joint flange 40 comprises a top side 41 and a side bottom 42. The joint flange 40 comprises three apertures extending through the joint flange 40 from the top side 41 to the bottom side 42: a wheel-connecting aperture 44; a first frame-connecting aperture 46a; and a second frame-connecting aperture 46b. The wheel-connecting aperture 44 is optionally threaded to provide a female coupling that engages a threaded male coupling mounted on the wheel assembly 30c.

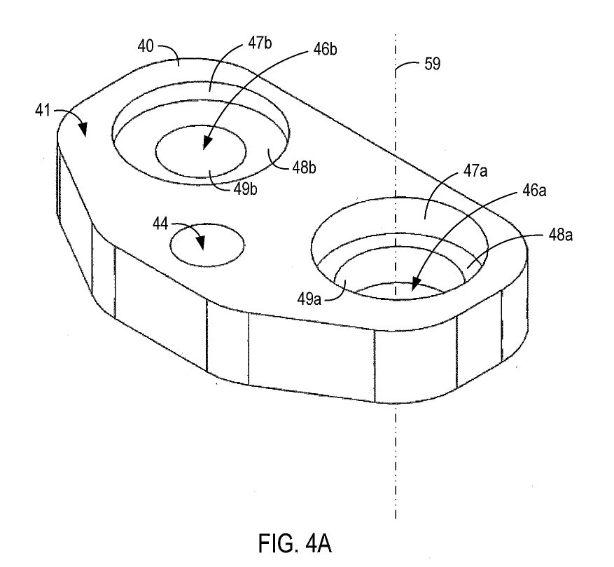

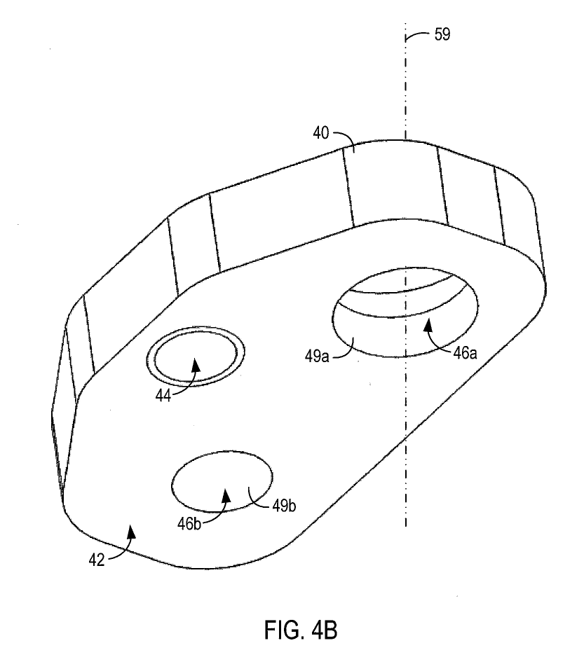

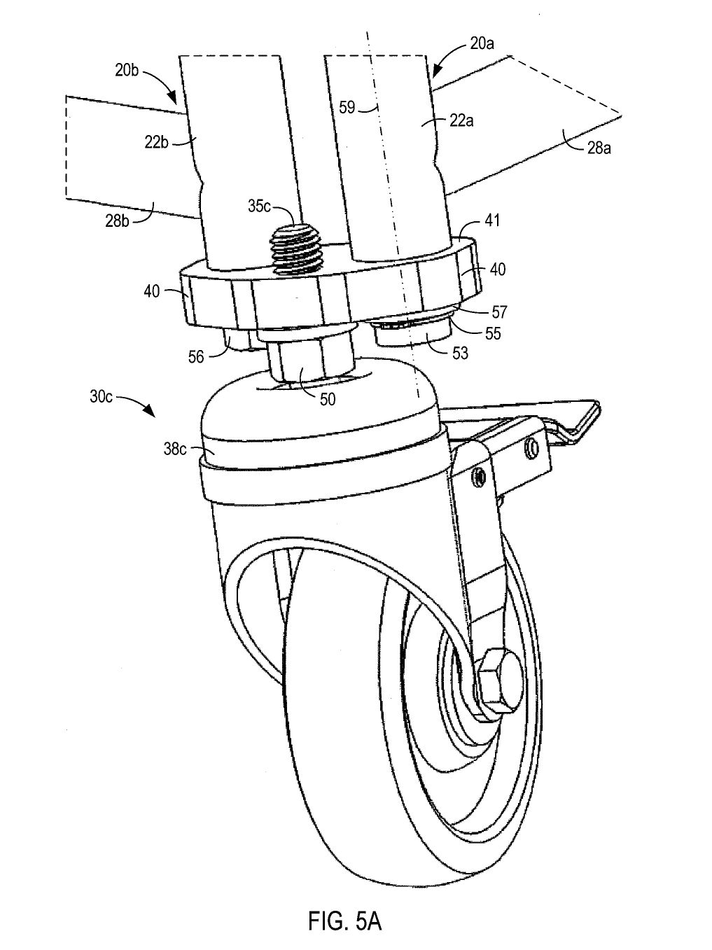

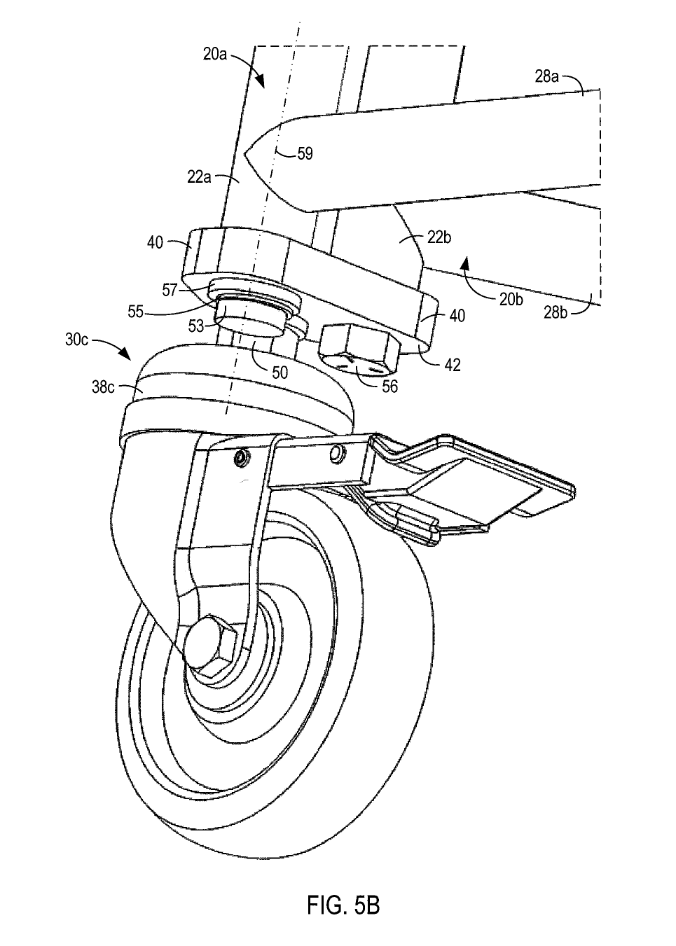

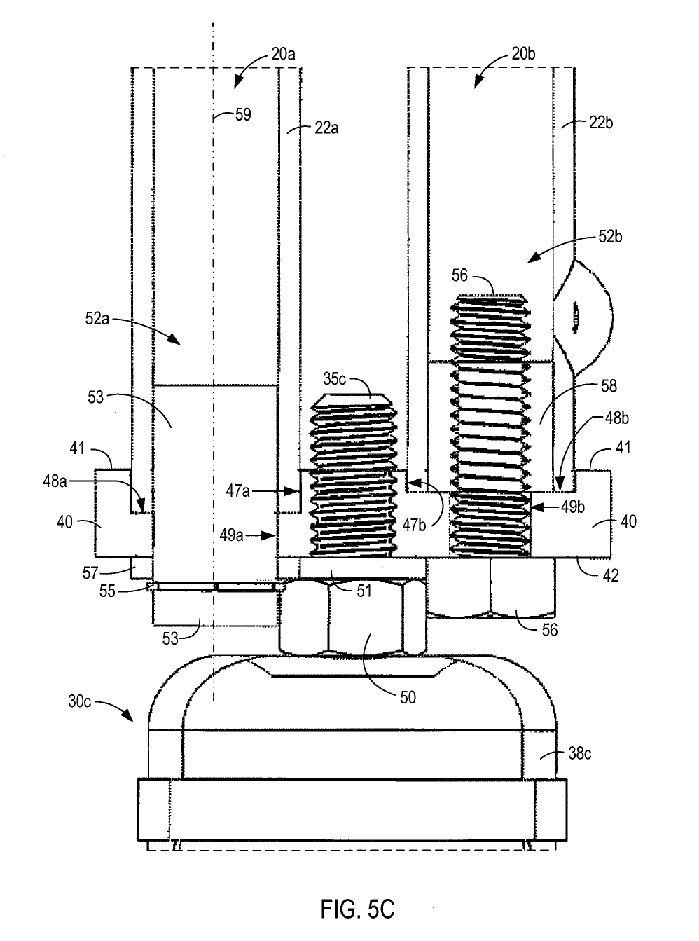

The first frame-connecting aperture 46a comprises a vertical frame-connecting surface 47a and a horizontal frame-connecting surface 48a. The horizontal frame-connecting surface 48a is counter-sunk below the top surface 41 of the joint flange 40. The vertical frame-connecting surface 47a is therefore located between the top surface 41 and the counter-sunk horizontal frame-connecting surface 48a. The first frame-connecting aperture 46a also comprises a sidewall 49a located between the counter-sunk horizontal frame-connecting surface 48a and the bottom surface 42. As described below in connection with FIGS. 5A-5C, the first frame-connecting aperture 46a is configured to rotatably connect the front vertical member 22a of the first frame 20a to the joint flange 40.

The second frame-connecting aperture 46b comprises a vertical frame-connecting surface 47b and a horizontal frame-connecting surface 48b. The horizontal frame-connecting surface 48b is counter-sunk below the top surface 41 of the joint flange 40. The vertical frame-connecting surface 47b is therefore located between the top surface 41 and the counter-sunk horizontal frame-connecting surface 48b. The second frame-connecting aperture 46b also comprises a sidewall 49b located between the counter-sunk horizontal frame-connecting surface 48b and the bottom surface 42. As described below in connection with FIGS. 5A-5C, the second frame-connecting aperture 46b is configured to fixedly connect the front vertical member 22b of the second frame 20b to the joint flange 40.

Referring to FIGS. 5A-5C, the wheel assembly 30c is connected to the joint flange 40 through the engagement of the male-threaded connector 35c with the female-threaded wheel-connecting aperture 44 and a female-threaded spacer nut 50. The female-threaded spacer nut 50 is positioned on the male-threaded connector 35c below the bottom surface 42 of the joint flange 40. A washer 51 is located between the top surface of the spacer nut 50 and the bottom surface 42 of the joint flange 40. Although not shown, a second female threaded nut can be positioned on the male-threaded connector 35c above the top surface 41 of the joint flange 40. The swivel joint 38c provides the wheel assembly 30c with rotational degrees of freedom in the horizontal plane relative to the joint flange 40.

The lower end of the front vertical member 22a of the first frame 20a is positioned in the first frame-connecting aperture 46a and rotatably-engages with the vertical frame-connecting surface 47a and the counter-sunk horizontal frame-connecting surface 48a. A frame-connecting rod 53 is located within the lower end of the hollow lumen 52a of the front vertical member 22a of the first frame 20a. The frame-connecting rod 53 extends from the hollow lumen 52a, through the portion of the first frame-connecting aperture 46a located below the counter-sunk horizontal frame-connecting surface 48a, and beyond the bottom surface 42 of the joint flange 40. The frame-connecting rod engages the inner wall of the hollow lumen 52a and the sidewall 49a of the first frame-connecting aperture 46a located between the counter-sunk horizontal frame-connecting surface 48a and the bottom surface 42. The frame-connecting rod 53 is secured in place with a retaining ring 55. The retaining ring 55 is spaced apart from the bottom surface 42 of the joint flange 40 by a washer 57.

The frame-connecting rod 53 rotatably connects the first frame 20a to the joint flange 40 so that the first frame 20a can rotate around a folding axis 59 while maintaining its connection to the joint flange 40. The folding axis 59 is defined by the connection of the first frame front vertical member 22a of the first frame 20a to the joint flange 40. The folding axis 59 is parallel and co-linear with the front vertical member 22a of the first frame 20a. The front vertical member 22a is prevented from horizontal translation by mechanical engagement with the vertical frame-connecting surface 47a of the first frame-connecting aperture 46a. The front vertical member 22a is prevented from downward vertical translation by mechanical engagement with the horizontal frame-connecting surface 48a of the first frame-connecting aperture 46a. The front vertical member 22a is prevented from upward vertical translation by mechanical engagement with the frame connecting rod 53 and the retaining ring 55. The front vertical member 22a is prevented from rotation in a vertical plane by mechanical engagement with the frame connecting rod 53 and the retaining ring 55. The front vertical member 22a, and thus the first frame 20a, can rotate relative to the joint flange 40 in a horizontal plane around the folding axis 59.

The lower end of the front vertical member 22b of the second frame 20b is positioned in the second frame-connecting aperture 46b and fixedly-engages with the vertical frame-connecting surface 47b and the counter-sunk horizontal frame-connecting surface 48b. A female-threaded insert 58 is secured (e.g., welded) within the lower end of the hollow lumen 52b of the front vertical member 22b. A male-threaded frame-connecting bolt 56 is positioned through the second frame-connecting aperture 46b, from below, and engages with the female-threaded insert 58 to fixedly connect the front vertical member 22b, and thus the second frame 20b, to the joint flange 40. The threaded engagement between the secured insert 58 and the frame-connecting bolt 56 prevents any movement of the front vertical member 22b, and thus the second frame 20b, relative to the joint flange 40. In the embodiment shown in FIGS. 5A-5C, the sidewall 49b of the second frame-connecting aperture 46b located between the counter-sunk horizontal frame-connecting surface 48b and the bottom surface 42 of the joint flange 40 is not threaded. However, it is to be understood that the sidewall 49b can optionally be female threaded so that the frame-connecting bolt 56 threadably engages both the sidewall 49b and the secured insert 58.

As shown in FIG. 4A, the horizontal frame-connecting surface 48a of the first frame-connecting aperture 46a is counter-sunk farther below the top surface 41 of the joint flange 40 than is the horizontal frame-connecting surface 48b of the second frame-connecting aperture 46b. Thus the vertical frame-connecting surface 47a of the first frame-connecting aperture 46a has a larger height dimension than the vertical frame-connecting surface 47b of the first frame-connecting aperture 46b. This difference in height dimension is a function of the different engagements of the first and second frames 20a and 20b with the joint flange 40—i.e., the first frame 20a is rotatably connected to the joint flange 40 so that the first frame 20a can rotate around the folding axis 59, whereas the second frame 20b is fixedly connected and cannot move relative to the joint flange 40. The greater height of the first vertical frame-connecting surface 47a ensures that the front vertical member 22a of the first frame 20a can rotate relative to the joint flange 40 in a horizontal plane while not rotating in a vertical plane or translating in any direction relative to the joint flange 40.

Referring back to FIGS. 1A-1D, as described above, the wheel assemblies 30a and 30b can be respectively connected to the first and second frames 20a and 20b through threaded connections into the rear vertical members 24a and 24b. In such embodiments, female-threaded inserts similar to the insert 58 can be secured (e.g., welded) within the lower ends of hollow lumens 54a and 54b of the rear vertical members 24a and 24b.

The joint flange 40 provides a common connection for the wheel assembly 30c, the first frame 20a, and the second frame 20b. The joint flange 40 also aligns the front vertical members 22a and 22b of the first and second frames 20a and 20b, thus providing a V-shaped orientation of the first frame 20a relative to the second frame 20b, and providing the folding joint 15 (FIGS. 1A-1D) of the foldable walker 10. The rotatable connection of the first frame 20a to the joint flange 40 with rotational degrees of freedom in the horizontal plane around the folding axis 59, and the fixed connection of the second frame 20b to the joint flange 40 with no degrees of freedom, together permit the folding and unfolding rotation of the first frame 20a toward and away from the second frame 20b around the folding axis 59, as illustrated by double-ended arrow 69 in FIGS. 1A-1D. This folding/unfolding rotation occurs along the folding joint 15.

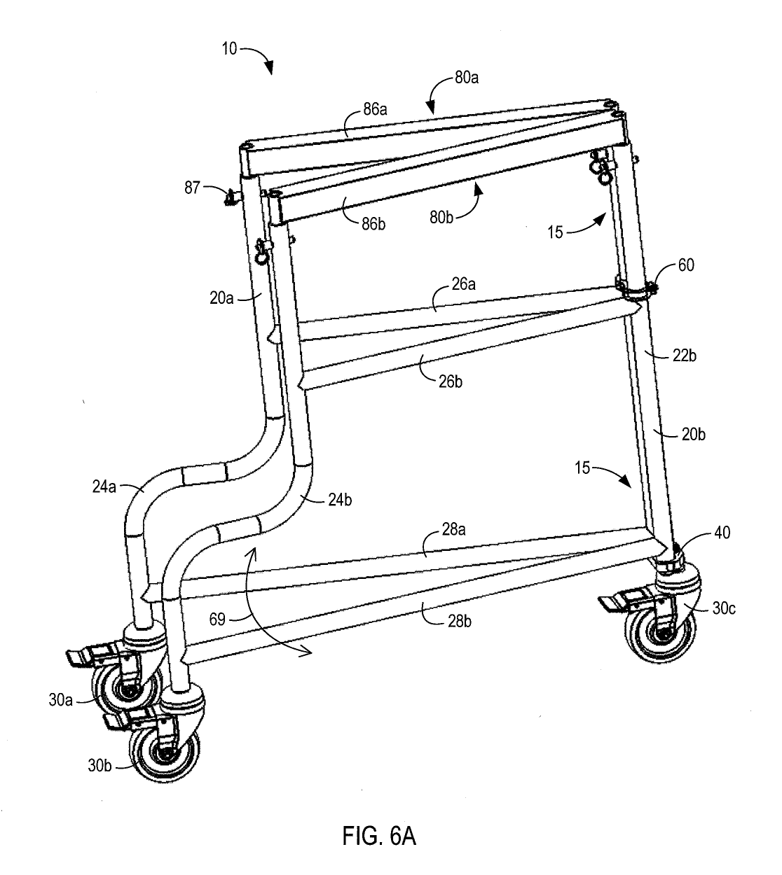

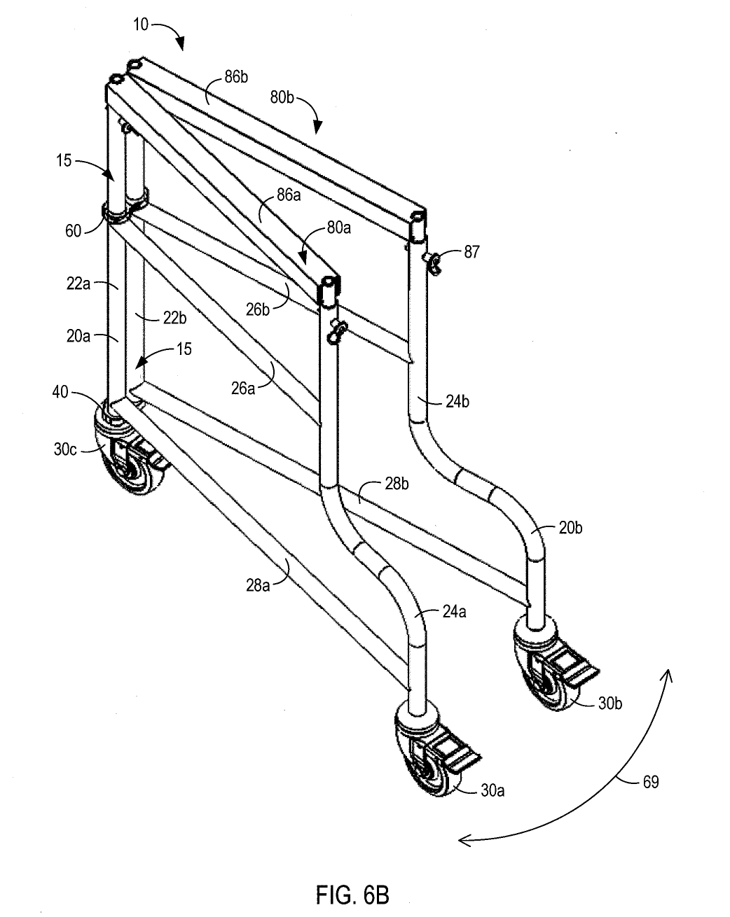

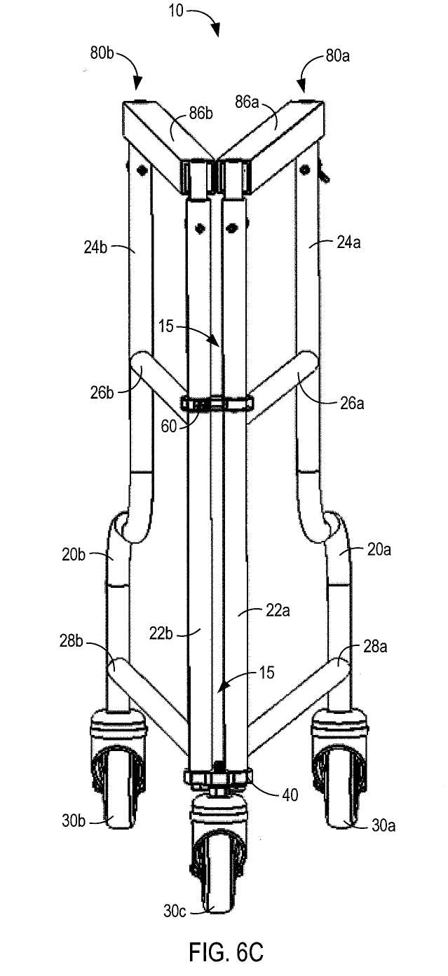

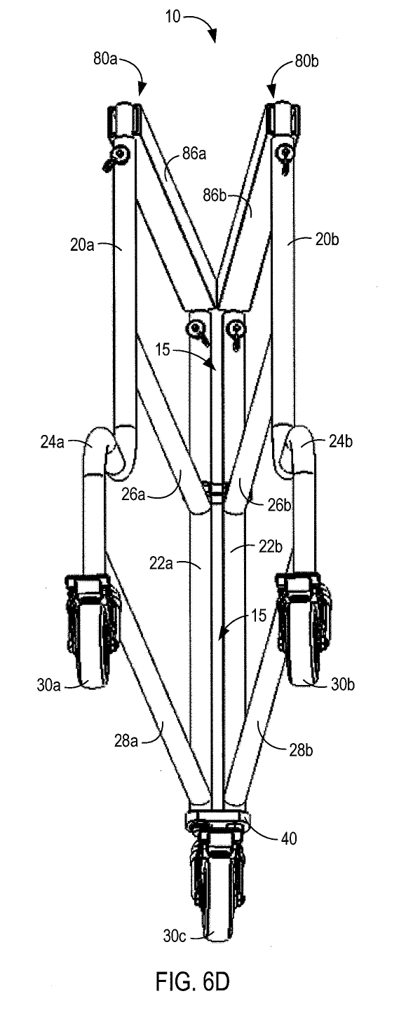

The folding and unfolding rotation of the first frame 20a toward and away from the second frame 20b along the folding joint 15 is also illustrated in FIGS. 6A-6D. FIGS. 6A-6D show the foldable walker 10 in a folded configuration and generally correspond to the views of the walker 10 shown in FIGS. 1A-1D in an unfolded configuration. The platform 70 is omitted from FIGS. 6A-6D for sake of clarity; however, as described below, when the walker 10 is in the folded configuration, the platform 70 is located in a folded orientation parallel and adjacent to the second platform support assembly 80b and the second frame 20b.

The joint flange 40 may be made of a material of construction such as, for example, aluminum or an aluminum-based alloy, titanium or a titanium-based alloy, steel, or a composite material (e.g., a fiber-reinforced polymer material such as, for example, carbon fiber-reinforced polymer). Aluminum and aluminum-based alloys (e.g., 6061-T6 aluminum alloy) provide an advantageous combination of low cost and high strength-to-weight ratio.

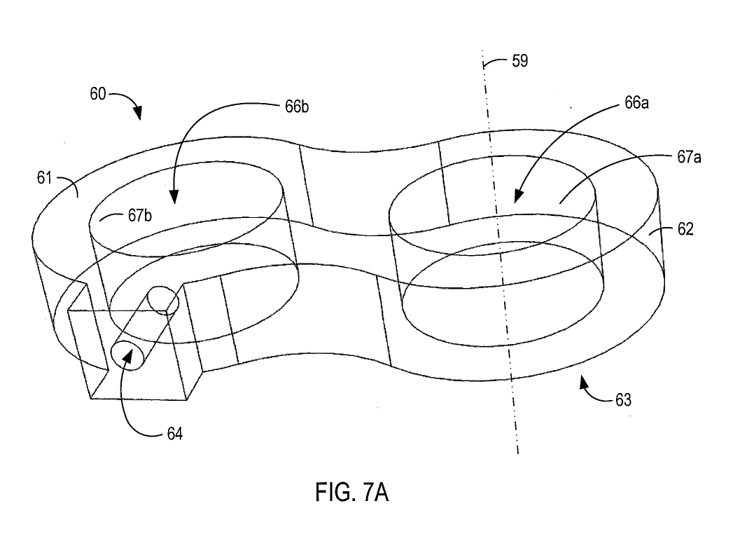

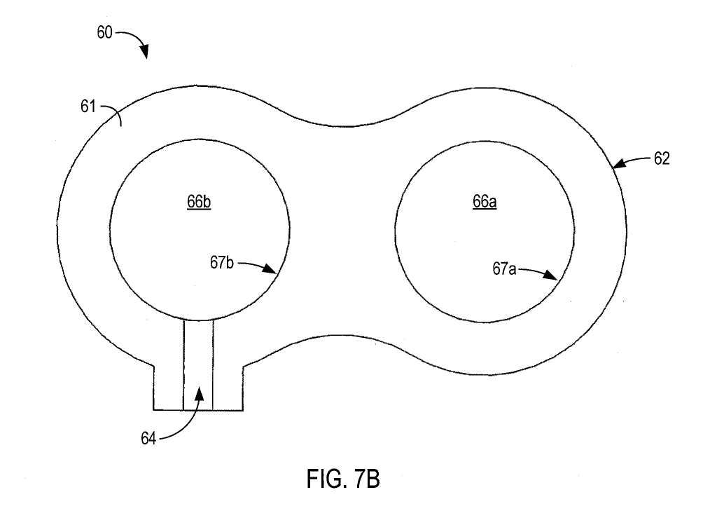

Referring again to FIGS. 1A-1D, the foldable walker 10 can further comprise a joint stabilization bracket 60. The joint stabilization bracket 60 is connected to and secures together the front vertical members 22a and 22b of the first and second frames 20a and 20b, and provides added stability to the folding joint 15 of the foldable walker 10. As shown in FIGS. 7A and 7B, the joint stabilization bracket 60 is formed from a single piece of material and comprises a top surface 61, a bottom surface 63, and an outer sidewall 62. The joint stabilization bracket 60 comprises a first frame-engagement aperture 66a and a second frame-engagement aperture 66b. The first and second frame-engagement apertures 66a and 66b extend through the thickness dimension of the joint stabilization bracket 60 from the top surface 61 to the bottom surface 62. The first and second frame-engagement apertures 66a and 66b each respectively comprise aperture sidewalls 67a and 67b. The joint stabilization bracket 60 further comprises a fastener aperture 64 extending between the outer sidewall 62 and the second frame-engagement aperture sidewall 67b.

The joint stabilization bracket 60 may be made of a material of construction such as, for example, plastic (e.g., acrylic resins), aluminum or an aluminum-based alloy, titanium or a titanium-based alloy, steel, or a composite material (e.g., a fiber-reinforced polymer material such as, for example, carbon fiber-reinforced polymer). Plastics, aluminum, and aluminum-based alloys (e.g., 6061-T6 aluminum alloy) provide an advantageous combination of low cost and high strength-to-weight ratio.

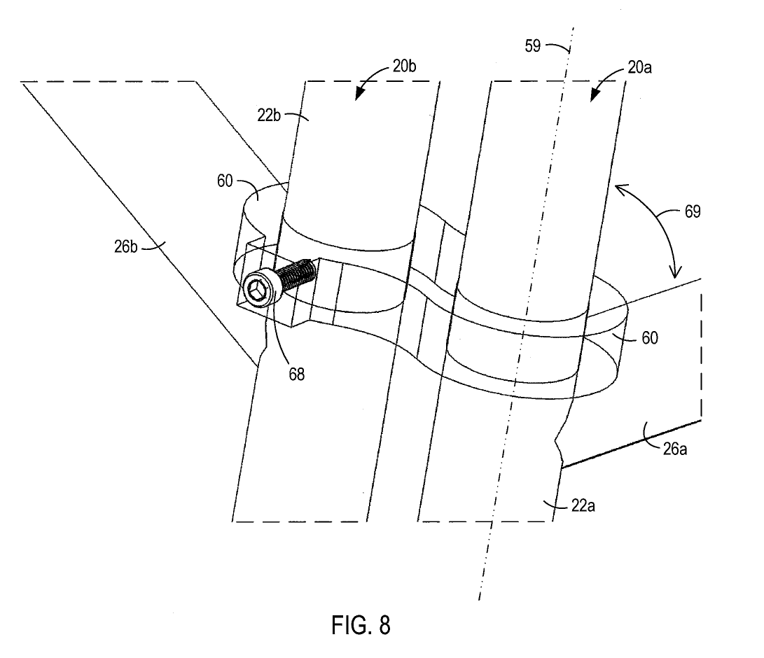

As shown in FIGS. 1A-1D and 7, the joint stabilization bracket 60 is connected to the first and second frames 20a and 20b, on the front vertical members 22a and 22b, and located above the upper horizontal members 26a and 26b. Referring to FIG. 8, the front vertical member 22b of the second frame 20b is positioned through the second frame-engagement aperture 66b, and the joint stabilization bracket 60 is fixedly connected to the front vertical member 22b with a fastener (e.g., screw 68) positioned through the fastener aperture 64 and engaging the outer surface of the front vertical member 22b. Like the connection of the front vertical member 22b to the joint flange 40 (see FIGS. 5A-5C), the front vertical member 22b is connected to the joint stabilization bracket 60 with no rotational or translational degrees of freedom.

The front vertical member 22a of the first frame 20a is positioned through the first frame-engagement aperture 66a, but the joint stabilization bracket is not fixedly connected to the front vertical member 22a. Thus, like the connection of the front vertical member 22a to the joint flange 40 (see FIGS. 5A-5C), the front vertical member 22a is connected to the joint stabilization bracket 60 with rotational degrees of freedom in the horizontal plane around folding axis 59.

The joint stabilization bracket 60 maintains the alignment between the front vertical members 22a and 22b, thus maintaining the V-shaped orientation of the first frame 20a relative to the second frame 20b, and maintaining the folding joint 15 (FIGS. 1A-1D and 6A-6D) of the foldable walker 10. The connection of the first frame 20a to the joint stabilization bracket 60 with rotational degrees of freedom in the horizontal plane around folding axis 59, and the connection of the second frame 20b to the joint stabilization bracket 60 with no degrees of freedom, maintains the folding and unfolding rotation of the first frame 20a toward and away from the second frame 20b, as illustrated by double-ended arrow 69, which occurs along the folding joint 15.

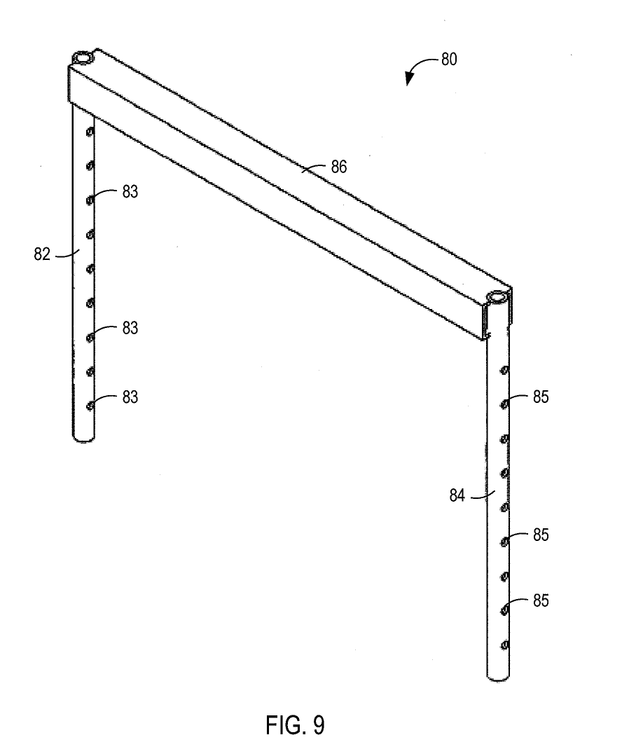

Referring again to FIGS. 1A-1D, the foldable walker 10 can further comprise a platform 70, a first platform support assembly 80a, and a second platform support assembly 80b. As shown in FIG. 9, the platform support assembly 80 (corresponding to the first and second platform support assemblies 80a and 80b) comprises a front telescoping member 82, a rear telescoping member 84, and a platform-connecting member 86 (in FIGS. 1A-1D and 6A-6D, the constituent members of the platform support assemblies 80a and 80b are correspondingly indicated as 82a, 82b, 84a, 84b, 86a, and 86b). The front telescoping member 82 and the rear telescoping member 84 are attached (e.g., welded) to opposite ends of the platform-connecting member 86. As attached, the front and rear telescoping members 82 and 84 are oriented vertically, and the platform-connecting member 86 is oriented horizontally. The front telescoping member 82 comprises a plurality of height adjustment apertures 83. The rear telescoping member 84 comprises a plurality of height adjustment apertures 85.

The constituent members of the first and second platform support assemblies 80a and 80b (i.e., the front telescoping members 82a/82b, the rear telescoping members 84a/84b, the platform connecting members 26a/26b) may be made of a material of construction such as, for example, aluminum or an aluminum-based alloy, titanium or a titanium-based alloy, steel, or a composite material (e.g., a fiber-reinforced polymer material such as, for example, carbon fiber-reinforced polymer). Hollow aluminum tubing or hollow aluminum-based alloy tubing (e.g., 6061-T6 aluminum alloy) provides an advantageous combination of low cost and high strength-to-weight ratio.

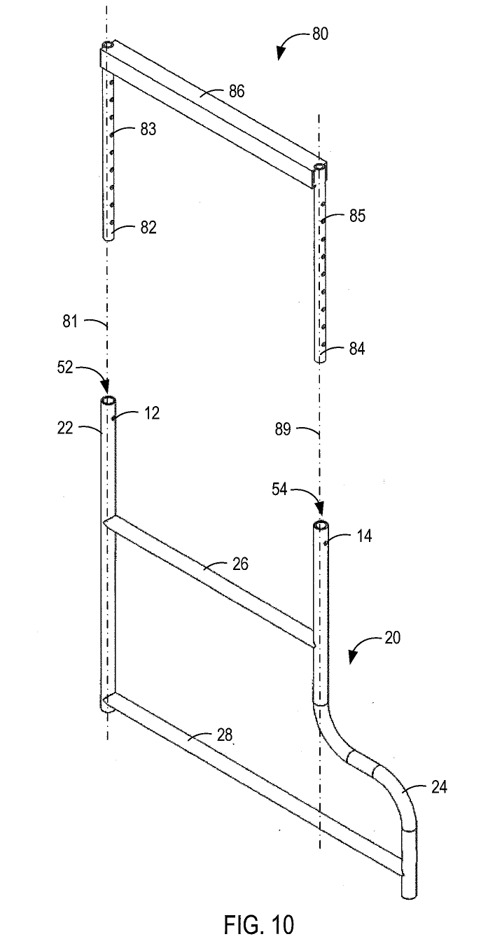

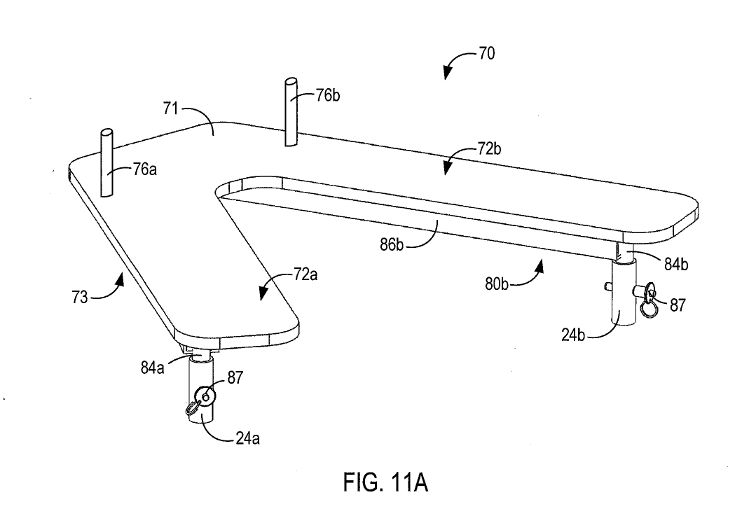

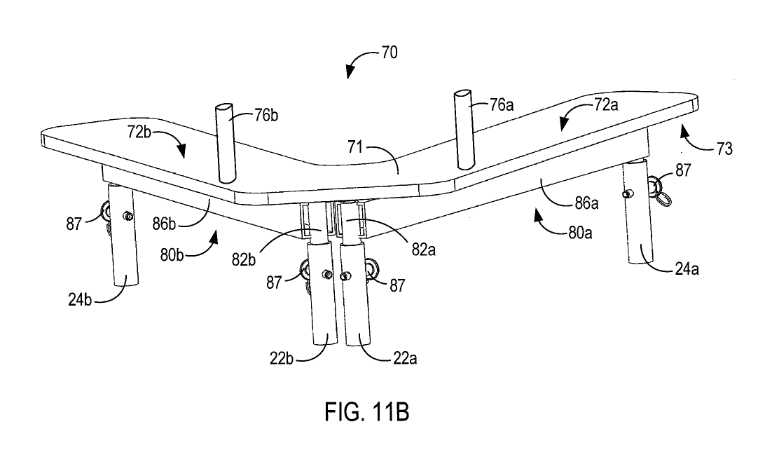

The first platform support assembly 80a and the second platform support assembly 80b are telescopingly connected to the first frame 20a and the second frame 20b. Referring to FIG. 10, the platform support assembly 80 is shown aligned with the frame 20 along front and rear alignment axes 81 and 89. The front telescoping member 82 of the platform support assembly 80 is aligned with the front vertical member 22 of the frame 20 along the front alignment axis 81. The rear telescoping member 84 of the platform support assembly 80 is aligned with the rear vertical member 24 of the frame 20 along the rear alignment axis 89. The platform support assembly 80 is telescopingly connected to the frame 20 by concentrically positioning the front telescoping member 82 inside the hollow lumen 52 of the front vertical member 22, and by concentrically positioning the rear telescoping member 84 inside the hollow lumen 74 of the rear vertical member 24. Thus, the first platform support assembly 80a and the second platform support assembly 80b are respectively telescopingly connected to the first frame 20a and the second frame 20b, as shown in FIGS. 1A-1D and 6A-6D, in which the front telescoping members 82a and 82b are concentrically positioned inside the front vertical members 22a and 22b, and the rear telescoping members 84a and 84b are concentrically positioned inside the rear vertical members 24a and 24b (see also FIGS. 11A and 11B).

As shown in FIGS. 1A-1D, the platform 70 is V-shaped and matches the V-shaped orientation of the first frame 20a relative to the second frame 20b along the folding joint 15 in the unfolded configuration. Referring to FIGS. 11A and 11B, the platform 70 comprises a top surface 71 and a bottom surface 73. The platform 70 also comprises a first side 72a and a second side 72b. The platform 70 further comprises a first handle 76a attached to the top surface 71 on the first side 72a, and a second handle 76b attached to the top surface 71 on the second side 72b (the handles 76a and 76b are omitted from FIGS. 1A-1D for ease of illustration, but it is understood that the embodiments shown in FIGS. 1A-1D can comprise handles).

The platform 70 may be made of a material of construction such as, for example, fiberboard, wood, plastic, metal, and the like. In various embodiments, the platform 70 may comprise a padded and covered substrate. For example, a substrate made of fiberboard, wood, plastic, metal, or the like may have a foam padding layer positioned over the top surface of the substrate, and an outer covering positioned over the padding layer. The outer covering may comprise a material or fabric that provides acceptable tactile sensation to a user of the foldable walker (e.g., nylon, vinyl, leather, and the like).

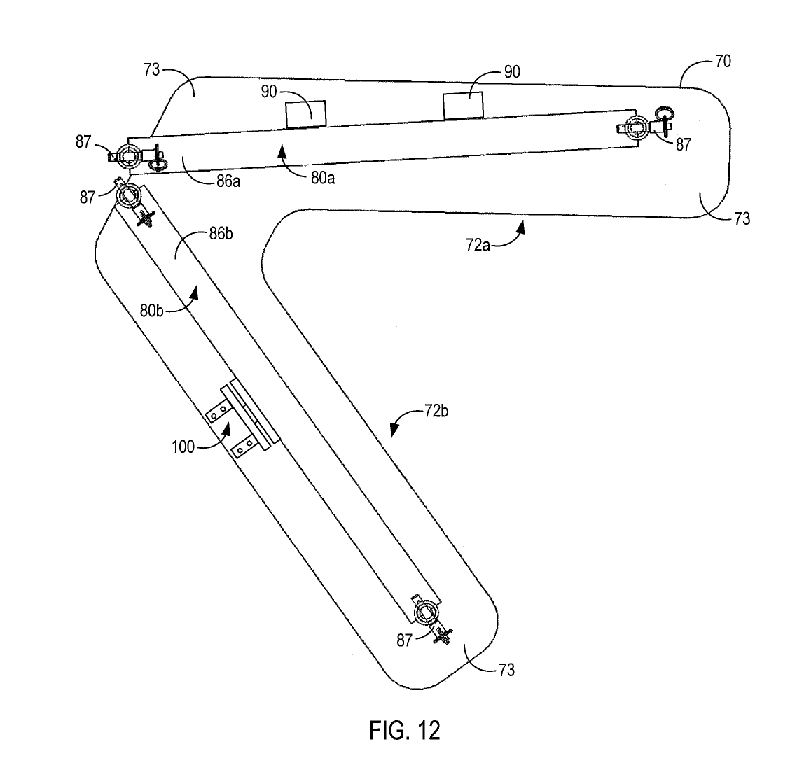

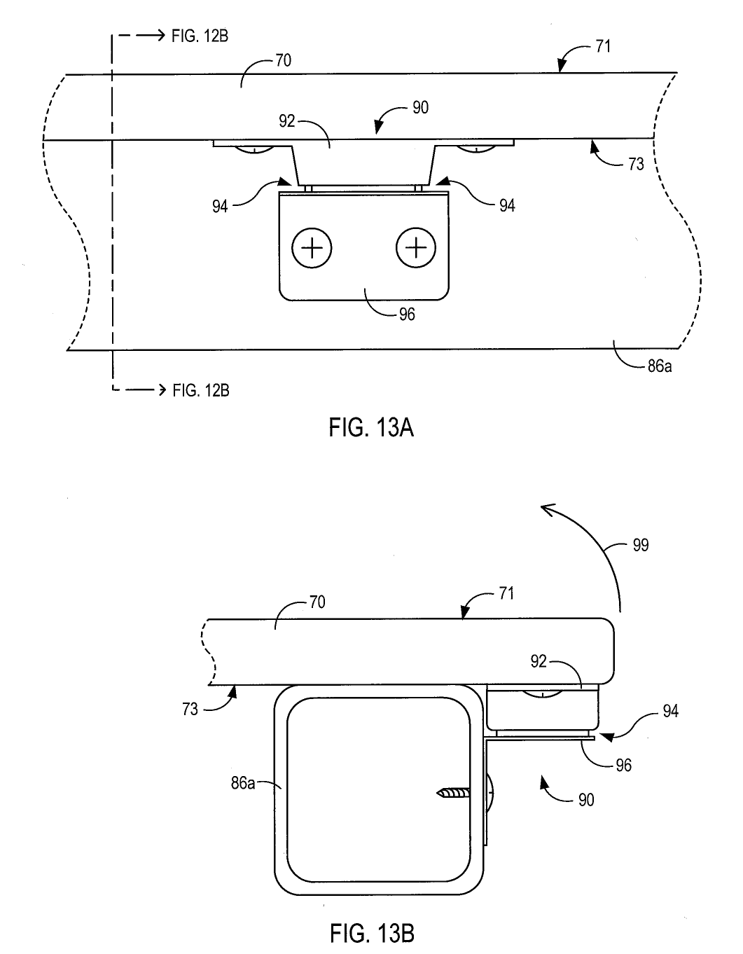

Referring to FIG. 12, the platform 70 is releasably connected to the first platform-connecting member 86a of the first platform support assembly 80a with magnetic locks 90. The platform 70 is connected to the second platform-connecting member 86b of the second platform support assembly 80b with a dual-axis hinge 100. The platform 70 is thus adjustably connected to the first and second frames 20a and 20b through the first and second platform support assemblies 80a and 80b, which are telescopingly connected to the first and second frames 20a and 20b.

Referring to FIGS. 13A and 13B, the magnetic lock 90 comprises magnets 94 secured in a housing 92. The magnetic lock 90 also comprises a magnet-engaging base 96. The housing 92 is attached to the bottom surface 73 of the platform 70. The magnet-engaging base 96 is attached to a side of the platform-connecting member 86a of the first platform support assembly 80a. While the housing 92 and the magnet-engaging base 96 are shown respectively attached to the platform 70 and the platform-connecting member 86a with screws, it is nevertheless understood that these attachments could be made with other types of mechanical fasteners or other types of joining mechanisms (e.g., with a weld). The magnet-engaging base 96 is made of a ferromagnetic material (e.g., steel) that is magnetically attracted to the magnets 94 with sufficient force to hold the platform 70 in place adjacent to the first platform-connecting member 86a of the first platform support assembly 80a, but which can be overcome by manual effort of a user of the foldable walker or other person. The magnetic engagement and disengagement of the magnets 94 to and from the base 96 provide the releasable connection of the platform 70 to the first platform-connecting member 86a of the first platform support assembly 80a.

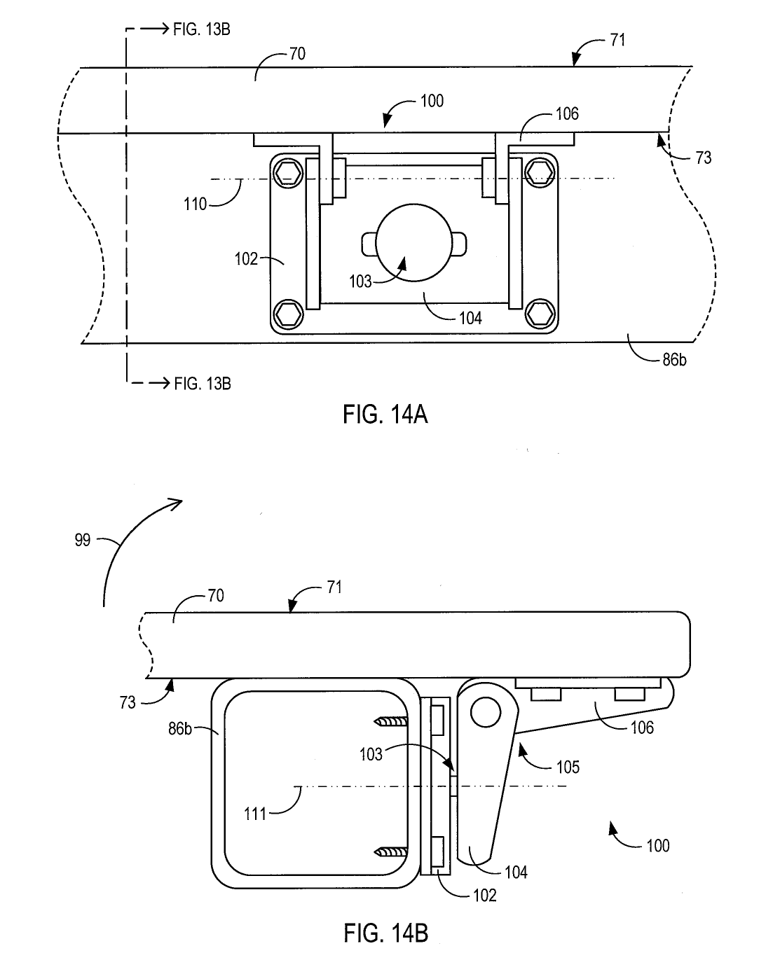

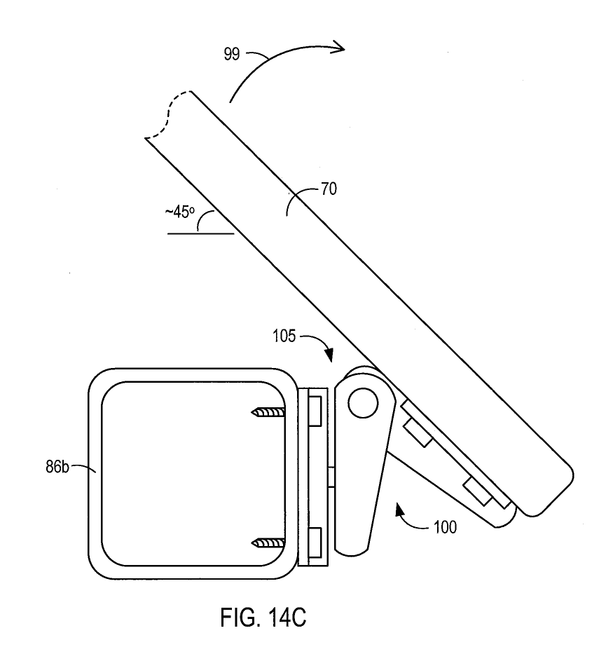

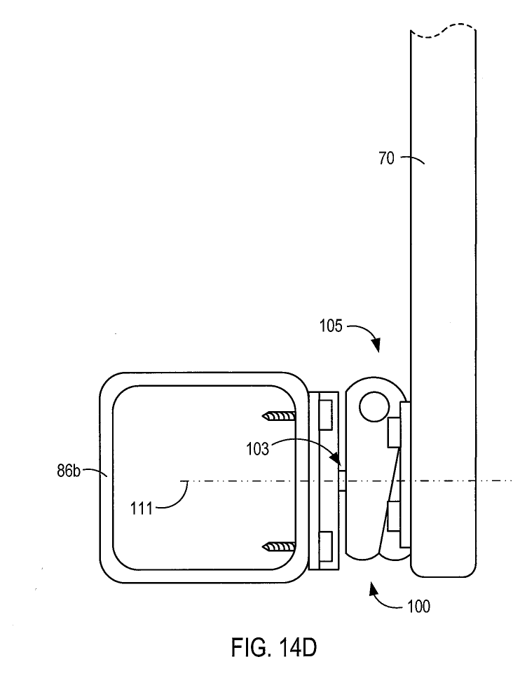

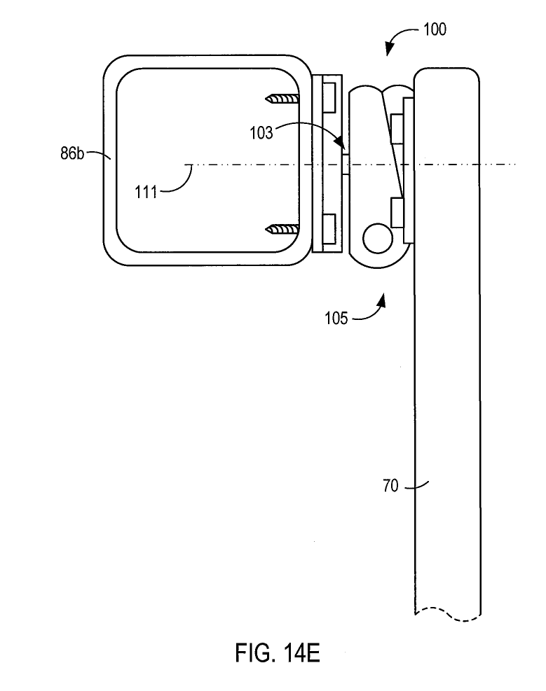

Referring to FIGS. 14A and 14B, the dual-axis hinge 100 comprises a base plate 102, a rotational plate 104, and a pivoting bracket 106. The base plate 102 is attached to a side of the platform-connecting member 86b of the second platform support assembly 80b. The pivoting bracket 106 is attached to the bottom surface 73 of the platform 70. While the base plate 102 and the pivoting bracket 106 are shown respectively attached to the platform-connecting member 86a and the platform 70 with screws, it is nevertheless understood that these attachments could be made with other types of mechanical fasteners or other joining mechanisms (e.g., with a weld).

The base plate 102 is attached to the rotational plate 104 through rotational joint 103. The rotational plate 104 is attached to the pivoting bracket 106 through pivoting joint 105. The pivoting joint 105 defines a pivoting axis 110 around which the pivoting bracket 106 and the attached platform 70 can rotate as indicated by arrow 99 in FIGS. 14B and 14C. The rotational joint 103 defines a vertical rotation axis 111 around which the rotational plate 104, the attached pivoting bracket 106, and the attached platform 70 can rotate within the vertical plane. The dual-axis hinge 100 thus allows the platform 70 to be folded from a horizontal position perpendicular to the platform support assemblies and the frames to a vertical position parallel and adjacent to the second platform support assembly 80b and the second frame 20b.

FIG. 14B shows the platform 70 in a horizontal position perpendicular to the platform-connecting member 86b and thus perpendicular to the second platform support assembly 80b and the second frame 20b (see FIGS. 1A-1D and 9). Referring to FIG. 13B, when the magnets 94 disengage from the base 96, the platform 70 rotates through pivoting joint 105 and around the pivoting axis 110 as indicated by the arrow 99 in FIGS. 13B and 14B. As the platform 70 rotates through the pivoting joint 105 and around the pivoting axis 110, the platform progresses from a horizontal orientation to a vertical orientation. FIG. 14C shows the platform 70 rotated about 45-degrees from the horizontal plane. FIG. 14D shows the platform 70 rotated about 90-degrees from the horizontal plane and thus oriented in the vertical plane.

Upon reaching a vertical orientation, as shown in FIG. 14D, the platform 70 is free to rotate in the vertical plane through the rotational joint 103 around the vertical rotation axis 111. FIG. 14E shows the platform 70 rotated around the vertical rotation axis 111 by about 180-degrees. In this position, the platform 70 is located in a folded orientation parallel and adjacent to the second platform support assembly 80b and the second frame 20b (see FIGS. 1A-1D, 6A-6D, and 9). In this position, the platform 70 is still connected to the second platform support assembly 80b and the second frame 20b, but is unconnected from the first platform support assembly 80b and the first frame 20b. This position of the platform 70 allows the folding rotation of the first frame 20a toward the second frame 20b around the folding joint 15, as illustrated by double-ended arrow 69 in FIGS. 1A-1D. The dual-axis rotational folding of the platform 70, and the folding and unfolding rotation of the first frame 20a toward and away from the second frame 20b around the folding joint 15, as illustrated by double-ended arrow 69 in FIGS. 1A-1D, 6A, and 6B, together provides the foldability of the foldable walker 10.

To facilitate the rotation of the platform 70 in the vertical plane through the rotational joint 103 of the dual-axis hinge 100 and around the vertical rotation axis 111, and to ensure the alignment of the folded platform 70 parallel and adjacent to the second platform support assembly 80b and the second frame 20b, the dual axis hinge 100 should be positioned on the side of the second platform-connecting member 86b at about the mid-point of the member, i.e., about equidistant from the front and rear telescoping members 82b and 84b. Similarly, the dual axis hinge 100 should be positioned on the bottom side 73 of the platform 70 at about the mid-point of the second side 72b.

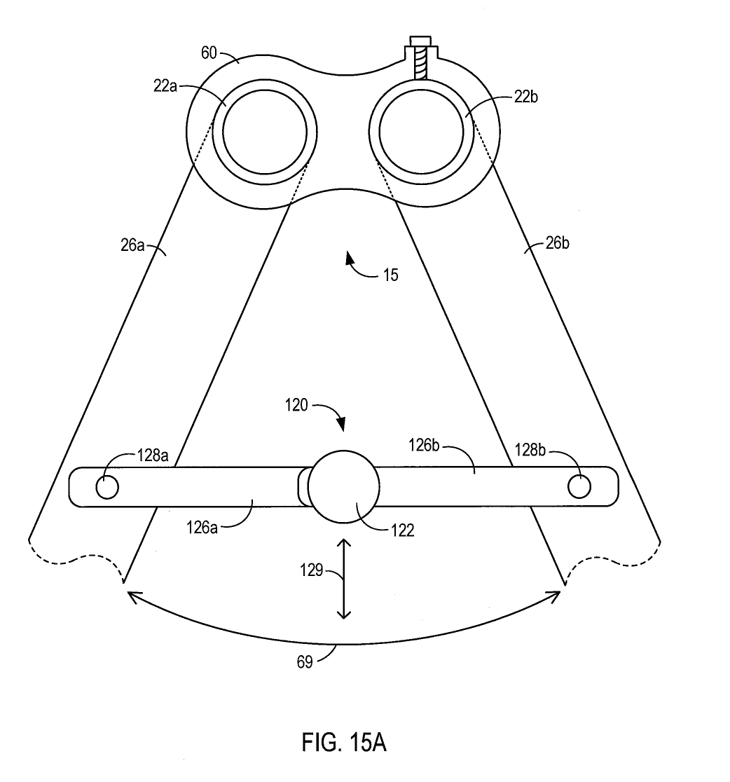

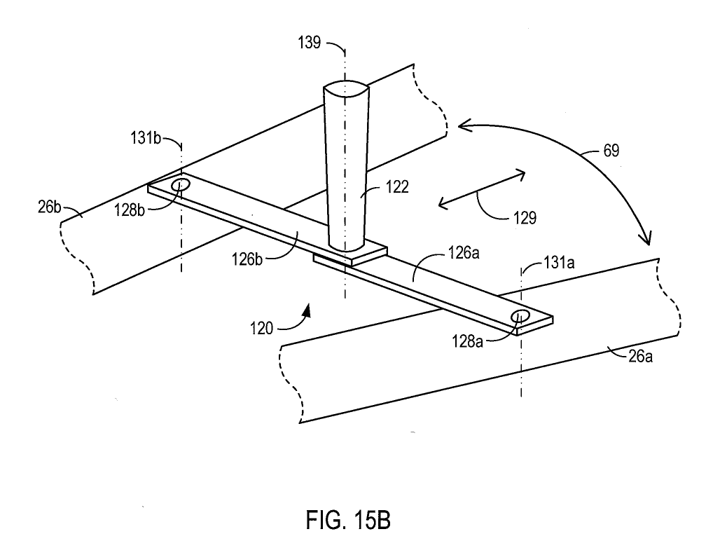

Although not shown in FIGS. 1A-1D and 6A-6D, the foldable walker 10 may further comprise a folding actuator that facilitates the folding and unfolding rotation of the first frame 20a toward and away from the second frame 20b around the folding joint 15. Referring to FIGS. 15A and 15B, a folding actuator 120 comprises an actuator handle 122 connected to a first lever arm 126a and to a second lever arm 126b. The first lever arm 126a is connected to the upper horizontal member 26a of the first frame 20a with a connector 128a. The second lever arm 126b is connected to the upper horizontal member 26b of the second frame 20b with a connector 128b. The connection between the actuator handle 122 and the first and second lever arms 126a and 126b permits rotation of the lever arms around a handle axis 139. The connection between the first lever arm 126a and the first upper horizontal member 26a permits rotation of the first lever arm 126a around a first levering axis 131a. The connection between the second lever arm 126b and the second upper horizontal member 26b permits rotation of the second lever arm 126b around a second levering axis 131b. The connectors 128a and 128b can be implemented, for example, with mechanical fasteners such as bolts, washers, nuts, and the like.

The handle axis 139 and the first and second levering axes 131a and 131b are generally parallel to the folding axis 59 (see FIGS. 4A-6A and 7) and the front and rear alignment axes 81 and 89 (see FIG. 9). The folding rotation of the first frame 20a toward the second frame 20b around the folding joint 15, as illustrated by double-ended arrow 69, can be actuated by pulling the actuator handle 122 rearwardly, away from the folding joint 15, as illustrated by the double-ended arrow 129 in FIGS. 15A and 15B. Similarly, the unfolding rotation of the first frame 20a away from the second frame 20b around the folding joint 15, as illustrated by double-ended arrow 69, can be actuated by pushing the actuator handle 122 forwardly, toward the folding joint 15, as illustrated by the double-ended arrow 129. In this manner, the rearward and forward movement of the actuator handle 122 provides a mechanical levering action that assists the folding and unfolding rotation of the first frame 20a.

The actuation of the folding and unfolding rotation of the first frame 20a through the motion of the actuator handle 122 requires first folding the platform 70 from a horizontal orientation to a vertical orientation (see FIGS. 13b-13C). As described above, the folding the platform 70 requires the disengagement of the magnets 94 from the base 96 to release the platform 70 from the first platform support assembly 80a, pivotal rotation of the platform 70 from a horizontal orientation to a vertical orientation, and vertical rotation of the platform 70 to a folded orientation parallel and adjacent to the second frame 20b.

As described above, the first frame 20a and the second frame 20b include height adjustment apertures 12a and 12b located in the front vertical members 22a and 22b, and height adjustment apertures 14a and 14b located in the rear vertical members 24a and 24b. The first platform support assembly 80a and the second platform support assembly 80b include height adjustment apertures 83a and 83b located in the front telescoping members 82a and 82b, and height adjustment apertures 85a and 85b located in the rear telescoping members 84a and 84b. The height of the platform 70 relative to the frames 20a and 20b can be adjusted by changing the distance that the front and rear telescoping members 82a, 84a, 82b, and 84b (of the platform support assemblies 80a and 80b) extend into the hollow lumens 52a, 52b, 54a, and 54b of the front and rear vertical members 22a, 24a, 22b, and 24b (of the frames 20a and 20b). A particular platform height can be set by aligning the height adjustment apertures 12a and 12b of the front vertical members 22a and 22b with the height adjustment apertures 83a and 83b of the front telescoping members 82a and 82b, aligning the height adjustment apertures 14a and 14b of the rear vertical members 24a and 24b with the height adjustment apertures 85a and 85b of the rear telescoping members 84a and 84b, and securing the alignment of the height adjustment apertures with pins 87.

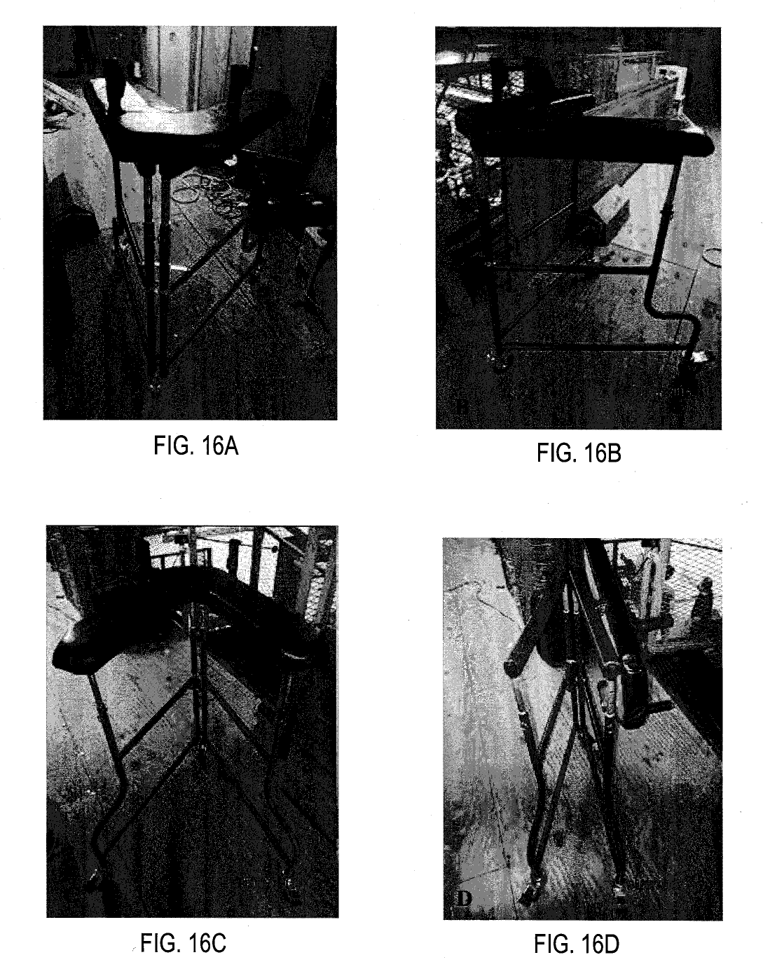

A prototype foldable walker was constructed in accordance with the embodiments described above. The prototype foldable walker is shown in FIGS. 16A-16D. FIG. 16A shows a front view of the prototype foldable walker in an unfolded configuration with the first frame rotated away from the second frame, and the platform positioned in a horizontal orientation and releasably connected to the first platform support assembly through a magnetic lock. FIG. 16B is a side view of the prototype foldable walker in an unfolded configuration, and FIG. 16C is a rear view of the prototype foldable walker in an unfolded configuration. FIG. 16D is a rear view of the prototype foldable walker in a folded configuration with the platform in a folded position parallel and adjacent to the second frame, and the first frame rotated toward the second frame.

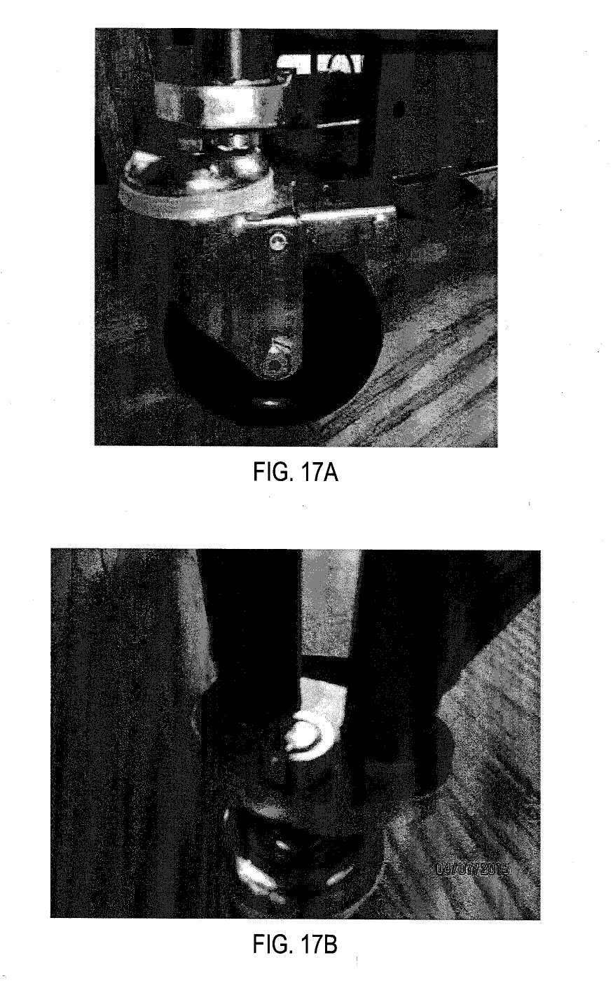

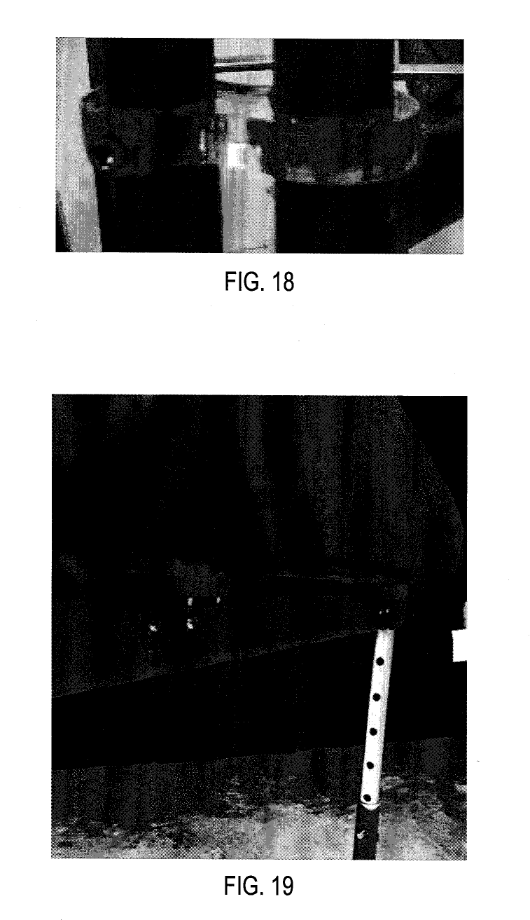

FIGS. 17A and 17B show the connection of the front wheel assembly and the front vertical members of the two frames to the joint flange of the prototype foldable walker. FIG. 18 shows the connection and positioning of the joint stabilization bracket to the front vertical members of the two main frames. FIG. 19 shows the connection and positioning of the magnetic locks to the platform and the platform-connecting member of the platform support assembly.

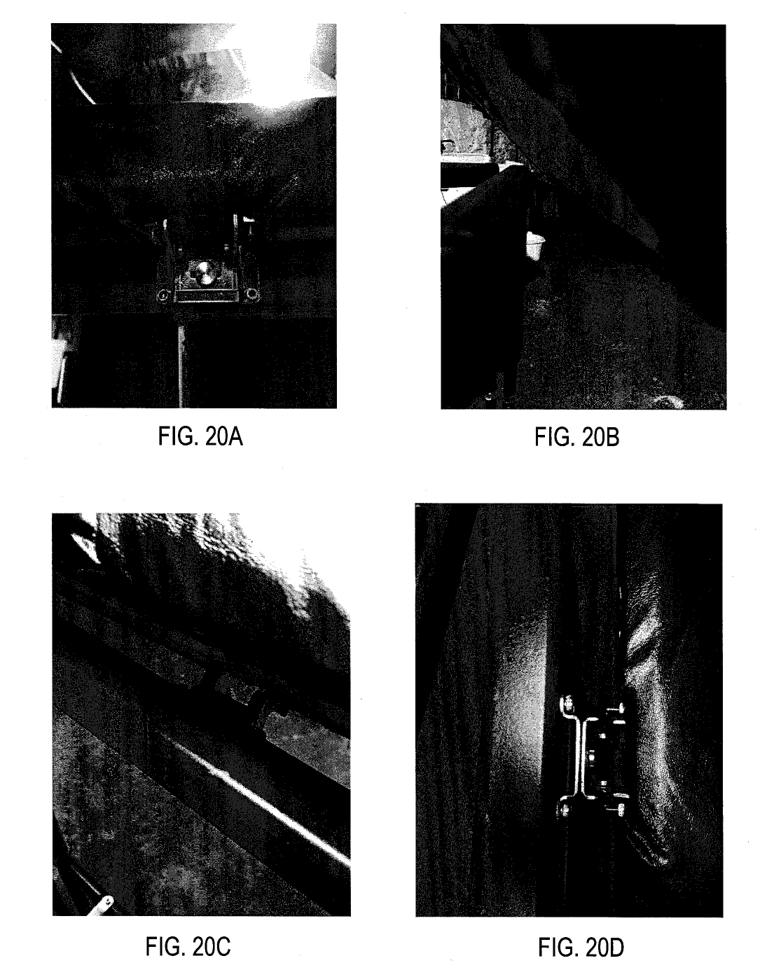

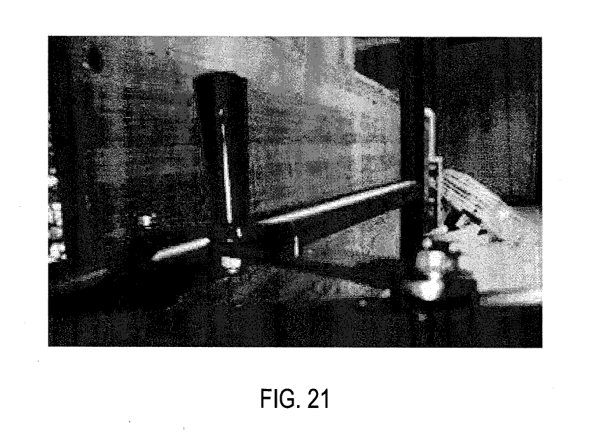

FIGS. 20A-20D show the connection and positioning of the dual-axis hinge to the platform and the platform-connecting member of the platform support assembly. FIG. 19A shows the platform in a horizontal position. FIGS. 20B and 20C show the platform rotated about 45-degrees from the horizontal plane around the pivoting axis of the dual-axis hinge. FIG. 20D shows the platform 70 rotated about 90-degrees from the horizontal plane around the pivoting axis of the dual-axis hinge, and thus oriented in the vertical plane, and further rotated around the vertical rotation axis of the dual-axis hinge by about 180-degrees. In the position shown in FIG. 20D, the platform is located in a folded orientation parallel and adjacent to the second platform support assembly and the second frame. FIG. 21 shows the folding actuator connected to the upper horizontal members of the two frames of the prototype foldable walker.

The prototype foldable walker was evaluated under and meets the requirements of ISO 11199-3:2005—Walking aids manipulated by both arms—Requirements and test methods—Part 3: Walking tables, which is incorporated by reference into this specification.

Referring again to FIGS. 1A-1E, during use the foldable walker 10 described in this specification is in an unfolded configuration with the first frame 20a rotated away from the second frame 20b, and the platform 70 positioned in a horizontal orientation and releasably connected to the first platform support assembly 80a. The platform 70 is vertically positioned to a height appropriate for a user by aligning the height adjustment apertures (12, 14, 83, and 85) and securing the set height with pins 87 or other suitable mechanism. A user stands between the two frames 20a and 20b, which are oriented in a V-shaped manner, and faces toward the folding joint 15 defined by the alignment the two frames and the connection of the two frames to the common joint flange 40. A user also stands between the two sides 72a and 72b of the platform 70, which is also V-shaped. Referring to FIGS. 11A and 11B, a user grasps the first handle 76a with their left hand, grasps the second handle 76b with their right hand, rests their left forearm on the top surface 71 of the first side 72a of the platform 70, and rests their right forearm on the top surface 71 of the second side 72b of the platform 70. A user can then walk with their upper body mass supported by the platform and guiding the motion of the foldable walker through the handles 76a and 76b.

The swivel joints 38 of the wheel assemblies 30 provide the foldable walker with two rotational degrees of freedom in the horizontal plane (clockwise and counterclockwise) and four translational degrees of freedom in the horizontal plane (forward, backward, leftward, and rightward). These degrees of freedom allow a user to walk with the foldable walker 10 forward, backward, leftward, and rightward, and to turn the foldable walker 10 while walking, and to spin the foldable walker while not walking. The three-wheeled structure shown in FIGS. 1A-1E, 6A-6D, and 15A-15D provide the foldable walker with a relatively tight turning radius not found in conventional rehabilitation walkers.

After use is discontinued, a user or other person (e.g., rehabilitation clinic personnel such as physical therapists or other clinicians such nurses, or another person assisting a user) can fold the foldable walker to save space while not in use. A person can disengage the platform from the platform support assembly (e.g., by pulling upwardly on the first side of the platform and disengaging the magnets of a magnetic lock connected to the platform from a base connected to the first platform support assembly). The disengaged platform and be rotated upwardly from the horizontal orientation to a vertical orientation, i.e., about 90-degrees along the pivoting axis of a dual axis hinge connected to the second side of the platform and the second platform support assembly. The vertically oriented platform can then be rotated by about 180-degrees along the vertical rotational axis of the dual axis hinge, thus placing the platform into a folded vertical orientation parallel and adjacent to the second platform support assembly and the second frame.

With the platform in a folded orientation, a user or other person can fold the frames of the foldable walker. For example, a user or other person can hold onto one of the two frames and pull the actuator handle of a manual folding actuator rearwardly, which levers the first frame toward the second frame around the folding joint of the foldable walker. The foldable walker is thus placed into a folded configuration (see FIGS. 6A-6D and 16D). In the folded configuration, the foldable walker possesses a relatively compact volume and foot print, while simultaneously retaining free-standing capability, which avoids the need for additional support equipment, or the need to lean the folded walker against other structures such as a wall or furniture, or to lay the folded walker on the floor.

To place the foldable walker back into an unfolded configuration for use, the same steps are performed in reverse. A user or other person can hold onto one of the two frames and push the actuator handle forwardly, which levers the first frame away from the second frame around the folding joint of the foldable walker. The platform can then be rotated by about 180-degrees along the vertical rotational axis of the dual axis hinge, thus placing the platform into an unfolded vertical orientation. The platform can then be rotated by about 90-degrees along the pivoting axis of the dual axis hinge, pivoting the platform from the vertical orientation back into the horizontal orientation. The first side of the platform can then be re-engaged with the first platform support assembly (e.g., by lowering the first side of the platform and engaging the magnets of a magnetic lock connected to the platform to a base connected to the first platform support assembly).

As described above, foldable walker described in this specification addresses and overcomes various problems with conventional rehabilitation walkers. The foldable walker's foldable V-shaped structure decreases the amount of space that the walker fills, both in the folded and unfolded configurations. The three-wheeled structure provides the foldable walker with improved handling characteristics, including a relatively tight turning radius not found in conventional four-wheeled rehabilitation walkers. The V-shaped, three-wheeled structure of the foldable walker also decreases the amount of material need for construction, thus decreasing weight. Additionally, the V-shaped structure of the platform does not obscures the lower portions of the foldable walker, thus providing users with direct visual feedback of their lower limbs, feet, and/or prostheses during gait, which can accelerate their rehabilitation. Furthermore, the frames of the walker are foldable around a single axis/joint, which simplifies the use of the folding/unfolding functionality, particularly compared to foldable four-wheeled walkers, which typically fold around two or four axes. Moreover, the relatively compact size and light weight of the foldable walker, particularly as compared to conventional rehabilitation walkers, permits the use of the foldable walker in home settings; whereas the relative bulk and heavy weight of conventional rehabilitation walkers generally limits such prior walkers to use in clinical rehabilitation settings.

Various features and characteristics of the inventions are described in this specification to provide an overall understanding of the disclosed foldable walker. It is understood that the various features and characteristics described in this specification can be combined in any suitable manner regardless of whether such features and characteristics are expressly described in combination in this specification. The Inventors/Applicants expressly intend such combinations of features and characteristics to be included within the scope of this specification. As such, the claims can be amended to recite, in any combination, any features and characteristics expressly or inherently described in, or otherwise expressly or inherently supported by, this specification. Furthermore, the Inventors/Applicants reserve the right to amend the claims to affirmatively disclaim features and characteristics that may be present in the prior art, even if those features and characteristics are not expressly described in this specification. Therefore, any such amendments will comply with the written description requirements under 35 U.S.C. §112(a) and will not add new matter to the specification or claims. The foldable walker described in this specification, and any components or component sub-assemblies, can comprise, consist of, or consist essentially of the various features and characteristics described in this specification.

Any patent, publication, or other disclosure material identified in this specification is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference. Any material, or portion thereof, that is incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and can be employed or used in an implementation of the described foldable walker. Further, the use of a singular noun includes the plural, and the use of a plural noun includes the singular, unless the context of the usage requires otherwise.

What is claimed is:

1. A foldable walker comprising:
a first frame rotatably connected to a joint flange;
a second frame fixedly connected to the joint flange, wherein the first frame is rotatable toward and away from the second frame around a folding axis defined by the connection of the first frame to the joint flange; and
a platform connected to the first frame and to the second frame.

2. The foldable walker of claim 1, further comprising:
a first platform support assembly telescopingly connected to the first frame; and
a second platform support assembly telescopingly connected to the second frame;
wherein the platform is releasably connected to the first platform support assembly and rotatably connected to the second platform support assembly.

3. The foldable walker of claim 2, wherein the first platform support assembly and the second platform support assembly each comprise:
a front telescoping member connected to an end of a platform-connecting member; and
a rear telescoping member connected to an opposite end of the platform-connecting member;
wherein the platform is releasably connected to the platform-connecting member of the first platform support assembly; and
wherein the platform is rotatably connected to the platform-connecting member of the second platform support assembly.

4. The foldable walker of claim 2, wherein the platform is releasably connected to the first platform support assembly through a magnetic lock.

5. The foldable walker of claim 2, wherein the platform is rotatably connected to the second platform support assembly through a dual-axis hinge.

6. The foldable walker of claim 1, wherein the first frame and the second frame each comprise:
a front vertical member;
a rear vertical member;
an upper horizontal member; and
a lower horizontal member;
wherein the upper horizontal member is connected to the front vertical member and the rear vertical member;
wherein the lower horizontal member is connected to the front vertical member and the rear vertical member;
wherein the front vertical member of the first frame is rotatably connected to the joint flange; and
wherein the front vertical member of the second frame is fixedly connected to the joint flange.

7. The foldable walker of claim 1, further comprising:
a first wheel assembly connected to the first frame;
a second wheel assembly connected to the second frame; and
a third wheel assembly connected to the joint flange;

8. The foldable walker of claim 1, further comprising a joint stabilization bracket connected to the first frame and the second frame.

9. The foldable walker of claim 8, wherein the joint stabilization bracket is fixedly connected to the second frame so that the second frame has no rotational degrees of freedom relative to the joint stabilization bracket, and wherein the joint stabilization bracket is not fixedly connected to the first frame so that the first frame has rotational degrees of freedom relative to the joint stabilization bracket.

10. The foldable walker of claim 1, further comprising a folding actuator connected to the first frame and to the second frame.

11. The foldable walker of claim 10, wherein the folding actuator comprises an actuator handle rotatably connected to a first lever arm and rotatably connected to a second lever arm, wherein the first lever arm is rotatably connected to the first frame, and wherein the second lever arm is rotatably connected to the second frame.

12. A foldable walker comprising:
a first frame rotatably connected to a joint flange;
a second frame fixedly connected to the joint flange, wherein the first frame and the second frame are oriented in a V-shape, and wherein the first frame is rotatable toward and away from the second frame around a folding axis defined by the connection of the first frame to the joint flange;
a first wheel assembly connected to the first frame;
a second wheel assembly connected to the second frame;
a third wheel assembly connected to the joint flange;
a joint stabilization bracket connected to the first frame and to the second frame;
a first platform support assembly telescopingly connected to the first frame;
a second platform support assembly telescopingly connected to the second frame; and
a platform releasably connected to the first platform support assembly and rotatably connected to the second platform support assembly.

13. The foldable walker of claim 12, wherein the first platform support assembly and the second platform support assembly each comprise:
a front telescoping member connected to an end of a platform-connecting member; and
a rear telescoping member connected to an opposite end of the platform-connecting member;
wherein the platform is releasably connected to the platform-connecting member of the first platform support assembly; and
wherein the platform is rotatably connected to the platform-connecting member of the second platform support assembly.

14. The foldable walker of claim 12, wherein the platform is releasably connected to the first platform support assembly through a magnetic lock, and wherein the platform is rotatably connected to the second platform support assembly through a dual-axis hinge.

15. The foldable walker of claim 12, wherein the first frame and the second frame each comprise:
a front vertical member;
a rear vertical member;
an upper horizontal member; and
a lower horizontal member;
wherein the upper horizontal member is connected to the front vertical member and the rear vertical member;
wherein the lower horizontal member is connected to the front vertical member and the rear vertical member;
wherein the front vertical member of the first frame is rotatably connected to the joint flange; and
wherein the front vertical member of the second frame is fixedly connected to the joint flange.

16. The foldable walker of claim 12, further comprising a folding actuator connected to the first frame and to the second frame.

17. The foldable walker of claim 16, wherein the folding actuator comprises an actuator handle rotatably connected to a first lever arm and to a second lever arm, wherein the first lever arm is rotatably connected to the first frame, and wherein the second lever arm is rotatably connected to the second frame.

18. The foldable walker of claim 12, wherein the joint stabilization bracket is fixedly connected to the second frame so that the second frame has no rotational degrees of freedom relative to the joint stabilization bracket, and wherein the joint stabilization bracket is not fixedly connected to the first frame so that the first frame has rotational degrees of freedom relative to the joint stabilization bracket.

19. A foldable walker comprising:
a first frame rotatably connected to a joint flange so that the first frame has rotational degrees of freedom relative to the joint flange;
a second frame fixedly connected to the joint flange so that the second frame has no rotational degrees of freedom relative to the joint flange, wherein the first frame and the second frame are oriented in a V-shape, wherein the first frame is rotatable toward and away from the second frame around a folding axis defined by the connection of the first frame to the joint flange, wherein the first frame and the second frame each comprise a front vertical member, a rear vertical member, an upper horizontal member, and a lower horizontal member, wherein the upper horizontal member and the lower horizontal member are each connected to the front vertical member and the rear vertical member, wherein the front vertical member of the first frame is rotatably connected to the joint flange, and wherein the front vertical member of the second frame is fixedly connected to the joint flange;
a first wheel assembly connected to the rear vertical member of the first frame;
a second wheel assembly connected to the rear vertical member of the second frame;
a third wheel assembly connected to the joint flange;
a joint stabilization bracket connected to the front vertical member of the first frame so that the first frame has rotational degrees of freedom relative to the joint stabilization bracket, wherein the joint stabilization bracket is fixedly connected to the front vertical member of the second frame so that the second frame has no rotational degrees of freedom relative to the joint stabilization bracket;
a first platform support assembly telescopingly connected to the first frame;
a second platform support assembly telescopingly connected to the second frame, wherein the first platform support assembly and the second platform support assembly each comprise a front telescoping member and a rear telescoping member connected to opposite ends of a platform-connecting member; and
a platform releasably connected to the platform-connecting member of the first platform support assembly and rotatably connected through a dual-axis hinge to the platform-connecting member of the second platform support assembly.

20. The foldable walker of claim 19, further comprising a folding actuator connected to the first frame and to the second frame, wherein the folding actuator comprises an actuator handle rotatably connected to a first lever arm and to a second lever arm, wherein the first lever arm is rotatably connected to the upper horizontal member of the first frame, and wherein the second lever arm is rotatably connected to the upper horizontal member of the second frame.
